(19) United States
(12) Patent Application Publication
(10) Pub. No.: US 2013/0218991 A1
(43) Pub. Date: Aug. 22, 2013

(54) METHOD AND SYSTEM FOR PROVIDING INFORMATION FROM A CUSTOMER RELATIONSHIP MANAGEMENT SYSTEM

(71) Applicants: Jager McConnell, San Francisco, CA (US); Ciara Peter, San Francisco, CA (US)

(72) Inventors: Jager McConnell, San Francisco, CA (US); Ciara Peter, San Francisco, CA (US)

(73) Assignee: salesforce.com, inc., San Francisco, CA (US)

(21) Appl. No.: 13/488,079

(22) Filed: Jun. 4, 2012

Related U.S. Application Data
(63) Continuation-in-part of application No. 13/401,514, filed on Feb. 21, 2012.

(51) Int. Cl. G06F 15/16

(52) U.S. Cl. 709/206

(57) ABSTRACT

A method for providing recommended information relating to a person from a customer relationship management (CRM) system is disclosed. The method embodiment includes receiving by a server a message from a user system associated with a user including a request for information relating to a target person and information identifying the target person. The method also includes identifying, based on the information identifying the target person, accessible records associated with an enterprise and relating to the target person, where the records are managed by a CRM system, and collecting public social media content relating to the target person from social networking entities. A comprehensive profile associated with the target person is generated based on the accessible records and on the social media content, and at least a portion of the profile is included in a response message that is transmitted by the server to the user system.

### CLAIM OF PRIORITY

This application is a continuation-in-part of U.S. patent application Ser. No. 13/401,514, filed Feb. 21, 2012 (Attorney Docket No. 1200.107.NPR1/681US1), the entire contents of which are incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

One or more implementations relate generally to an automated process for providing information from a customer relationship management system on a cloud computing platform.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions.

Customer relationship management (CRM) refers to methodologies and strategies for helping an enterprise develop and manage customer relationships in an organized way. A CRM system typically refers to a software-based solution implemented on one or more computer devices that collect, organize and manage customer and sales information. Most CRM systems include features that allow an enterprise to track and record interactions, including emails, documents, jobs, faxes, and scheduling. These systems typically focus on accounts rather than on individual contacts. They also generally include opportunity insight for tracking sales pipelines and can include added functionality for marketing and service. Other CRM systems also offer sales force automation features that streamline all phases of the sales process. For example, such CRM systems can support tracking and recording every stage in the sales process for each prospective customer, from initial contact to final disposition. In addition, CRM systems can support enterprise marketing, technical/customer support and service, event and meeting calendaring, and predictive analytics.

Typically, a CRM system can collect, store and analyze volumes of information depending on the various features supported. This information can be accessed by enterprise personnel across different groups, e.g., marketing, sales, technical support, and in some cases, by customers and external business partners. Accordingly, the CRM system can support and encourage collaboration between enterprise groups, and can help an enterprise to understand and to identify its customer needs, and effectively to build relationships between the enterprise, its customer base, and external partners.

While CRM systems are very powerful and have the potential to provide enormous benefits for an enterprise, using such a system can be challenging, if not prohibitive. In some cases, the CRM system's user interface can be counter intuitive to a user and/or far too complex to allow easy navigation to records the user is seeking. Moreover, the user may not be aware of the full capabilities of the CRM system and therefore, may not take full advantage of the features offered by the system. Accordingly, unless a user is adequately trained and/or possesses a familiarity with CRM or similar systems, it is unlikely that the CRM system will be used to its full potential, if at all.

### BRIEF DESCRIPTION OF THE DRAWINGS

In the following drawings like reference numbers are used to refer to like elements. Although the following figures depict various examples, the one or more implementations are not limited to the examples depicted in the figures.

FIG. 1A is an operational flow diagram illustrating a high level overview of an exemplary method for providing recommended information to a user system from a CRM system according to an embodiment;

FIG. 1B is an operational flow diagram illustrating a high level overview of an exemplary method for presenting recommended information from a CRM system according to an embodiment;

FIG. 1C is an operational flow diagram illustrating a high level overview of an exemplary method for providing information relating to a person from a CRM system according to an embodiment;

FIG. 1D is an operational flow diagram illustrating a high level overview of an exemplary method for providing information relating to an account from a CRM system according to an embodiment;

FIG. 2 illustrates a representative system for providing and presenting information from a CRM system according to an embodiment;

FIG. 3A is a block diagram representing an exemplary system for providing information to a user system from a CRM system according to an embodiment;

FIG. 3B is a block diagram representing an exemplary recommendation service hosted by a server for providing information to a user system from a CRM system according to another embodiment;

FIG. 4A is a block diagram representing an exemplary system for presenting information from a CRM system according to an embodiment;

FIG. 4B is a block diagram representing an exemplary recommendation component in a user system configured for presenting information from a CRM system according to an embodiment;

FIG. 5A illustrates an exemplary user system displaying information from a CRM system according to an embodiment;

FIG. 5B illustrates an exemplary user system displaying information from a CRM system according to another embodiment;

FIG. 5C illustrates an exemplary user system displaying information from a CRM system according to another embodiment;

FIG. 5D illustrates an exemplary user system displaying information from a CRM system according to another embodiment;

FIG. 5E illustrates an exemplary user interface displayed by a user system presenting information relating to a person according to an embodiment;

FIG. 5F illustrates an exemplary user interface displayed by a user system presenting information relating to an account according to an embodiment;

FIG. 6 illustrates a block diagram of an example of an environment where an on-demand database service might be used; and

FIG. 7 illustrates a block diagram of an embodiment of elements of FIG. 6 and various possible interconnections between these elements.

### DETAILED DESCRIPTION

### General Overview

Systems and methods are provided for providing and presenting information from a CRM system in a cloud computing environment. According to exemplary embodiments, a CRM recommendation service is configured to search for and retrieve records from a CRM system that are timely and personally relevant to a user and/or are relevant to an enterprise, and to provide those recommended records to a user system of the user so that they can be presented in real time to the user. In an embodiment, when the CRM recommendation service receives a request for recommended information from a requesting user system of the user, the CRM recommendation service is configured to also receive real-time user-specific information stored on the requesting user system and/or enterprise-specific information. For example, the user-specific information can include information relating to the user's contacts and historical and real-time information relating to the user's business and/or personal interactions with those and other contacts, and the enterprise-specific information can include information identifying the enterprise, a product name, and an industry of the enterprise. Additionally or alternatively, the user-specific information can include calendaring information that indicates the user's past, pending and future events, appointments, and/or meetings.

According to an embodiment, when the request and the user-specific and/or enterprise-specific information are received, the CRM recommendation service can be configured to identify accessible records that are related to the user-specific and/or enterprise-specific information, and managed by the CRM system. Once related accessible records have been identified, the CRM recommendation service can be configured to determine a relevance score for one or more of the identified accessible records based on one or more relevancy factors. In an embodiment, the relevance score of a record can reflect the importance or relevance of the record to the user and/or to the enterprise. Accordingly, the relevance factors can be directed to how often and when the user interacts with a record, a relationship between a record and the user, when an event is taking place, and/or who is attending an event. Alternatively or in addition, the relevance factors can be directed to an amount of revenue generated for the enterprise by a record, and/or a frequency with which the enterprise has interactions with a record.

Once relevance scores have been determined for at least some of the identified accessible records, the CRM recommendation service can be configured to identify one or more recommended records based on their respective relevance scores and to transmit information identifying the recommended records in a response message to the requesting user system.

According to another embodiment, the CRM recommendation service is configured to retrieve information from the CRM system and information from social networking entities related to a particular person or to a particular account, and to generate a comprehensive profile associated with the person or the account that paints a portrait of the person or the account from the perspective of an enterprise associated with the user. In an embodiment, the comprehensive profile for the person can identify people associated with the enterprise with whom the person is connected, correspondence involving the enterprise and the person, and/or social media activity relating to the enterprise and to the person. Similarly, the comprehensive profile for the account can identify people associated with the enterprise and with the account, correspondence involving the enterprise and the account, and social media activity relating to the account. In an embodiment, the comprehensive profile of the person or the account can be transmitted to the user system of the user so that it can be presented in real time to the user.

Providing Information Relevant to a User and/or to an Enterprise

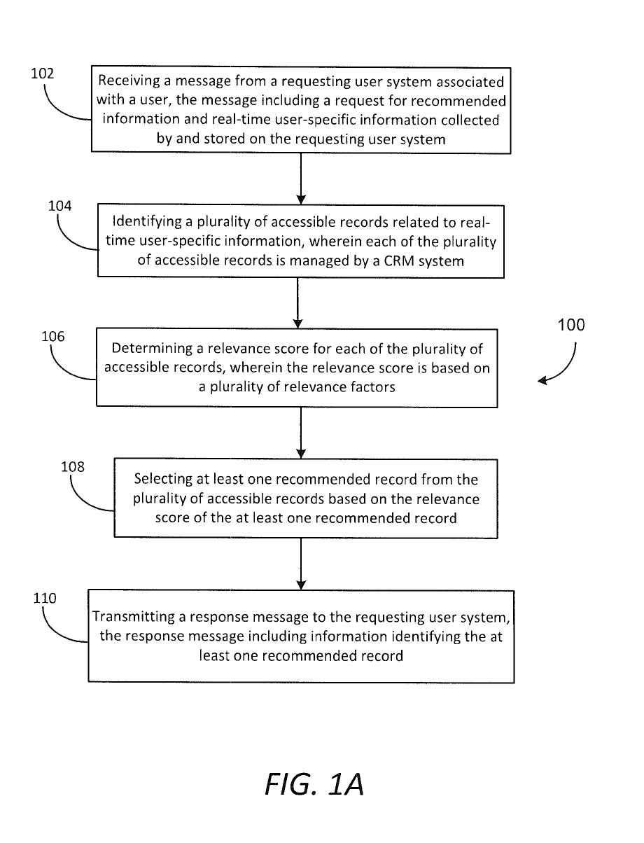

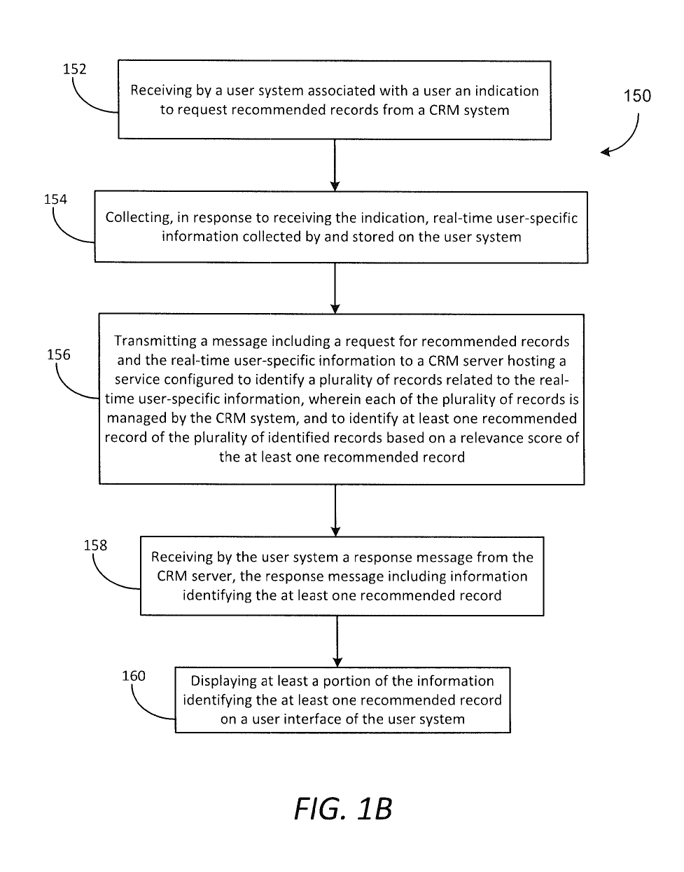

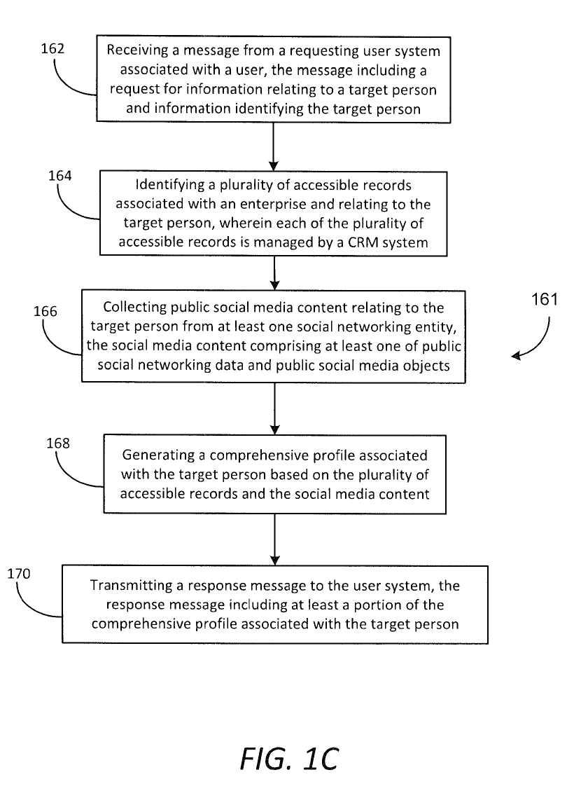

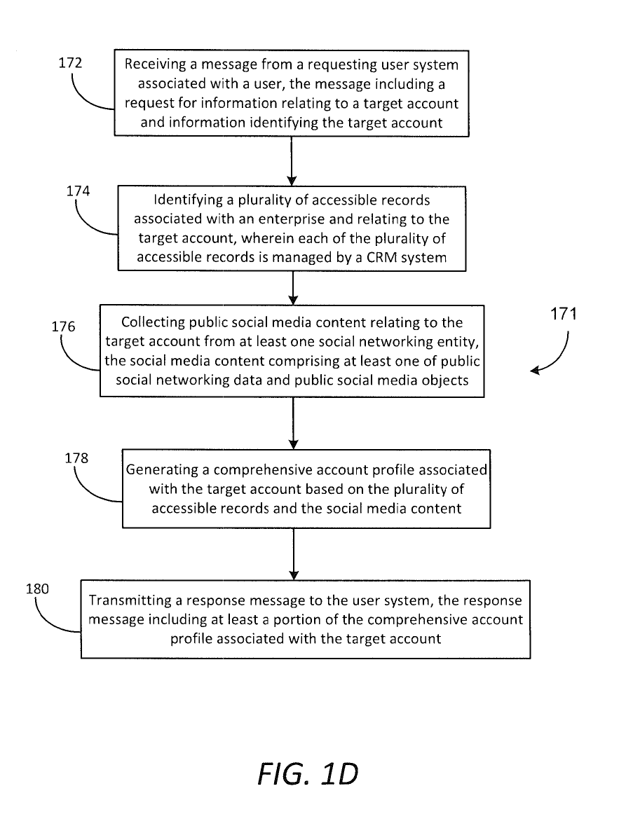

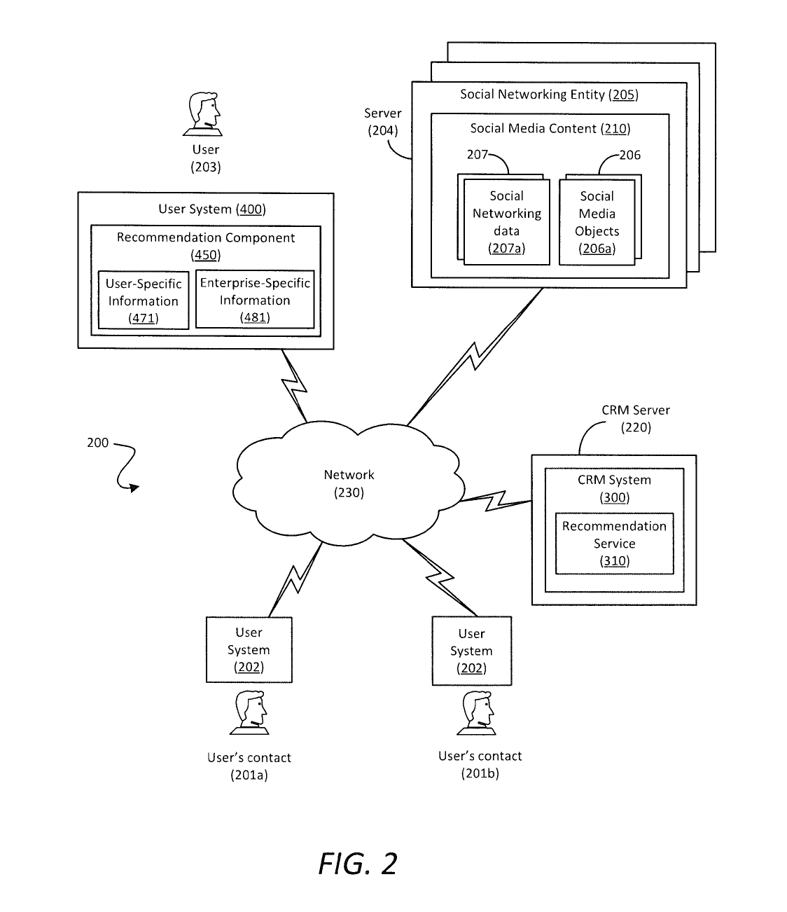

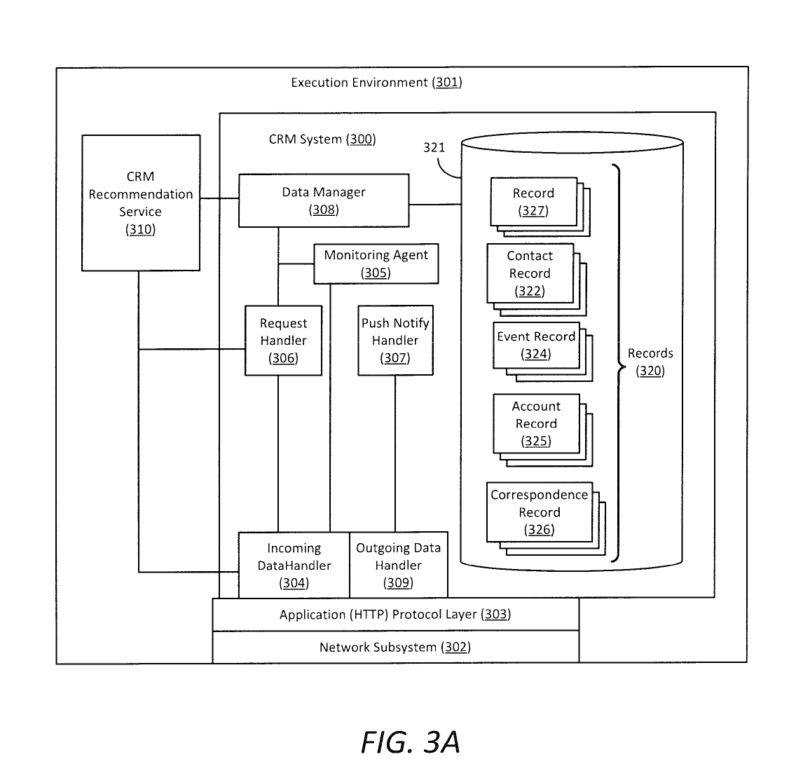

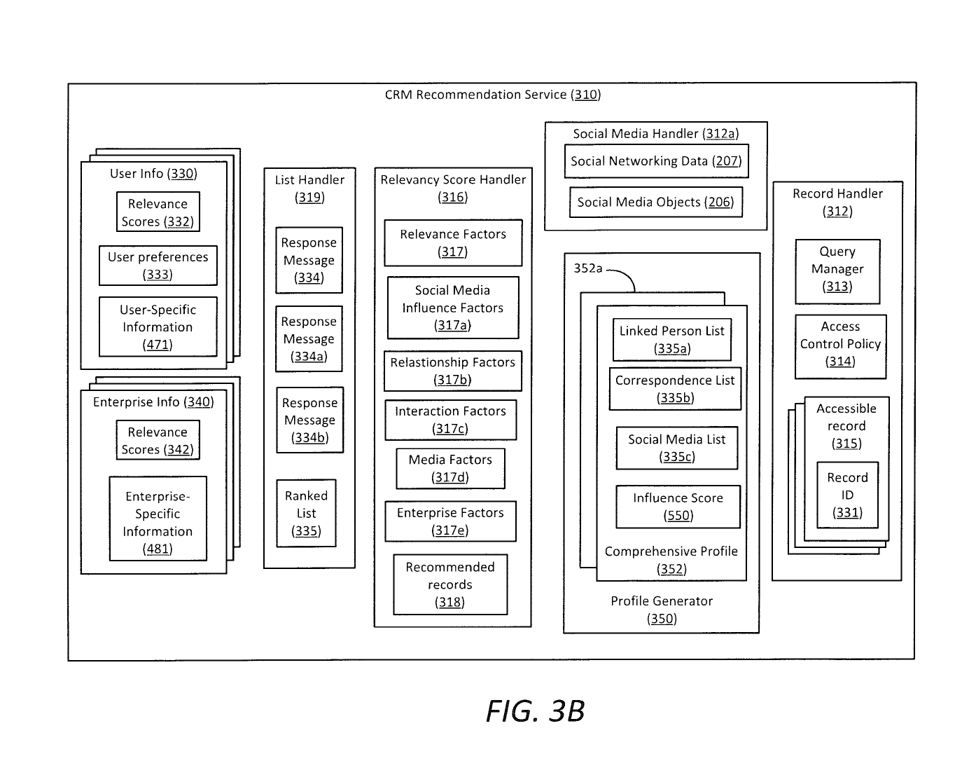

Referring now to FIG. 1A, a flow diagram is presented illustrating a method 100 for providing information to a user system from a CRM system according to an embodiment. FIG. 2 illustrates a representative system 200 for providing and presenting information to a user system from a CRM system according to an embodiment. FIG. 3A is a block diagram illustrating an exemplary system for providing information to a user system from a CRM system and in particular, illustrates an arrangement of components configured to implement the method 100 of FIG. 1A, which also can be carried out in environments other than that illustrated in FIG. 3A.

FIG. 3A illustrates components that are configured to operate within an execution environment hosted by a physical or virtual computer node and/or multiple computer nodes, as in a distributed execution environment. Exemplary computer nodes can include physical or virtual desktop computers, servers, networking devices, notebook computers, PDAs, mobile phones, digital image capture devices, and the like. For example, FIG. 2 illustrates a plurality of user system computer nodes 202, 400 and application server nodes 204, 220 communicatively coupled to one another via a network 230, such as the Internet. In an embodiment, a CRM application server 220 can be configured to provide an execution environment configured to support the operation of the components illustrated in FIG. 3A and/or their analogs. One example of such a CRM server 220 will be described later in greater detail during reference to later illustrated embodiments.

According to an embodiment, each user system node 202, 400 can represent a virtual or physical computer device through which a user, e.g., user 203, can communicate, via the network 230, with contacts 201a, 201b, and with application servers, such as a social networking server 204 and the CRM server 220. In an embodiment illustrated in FIG. 3A, a CRM system 300 includes components adapted for operating in an execution environment 301. The execution environment 301, or an analog, can be provided by a node such as the application server node 220. The CRM system 300 can include an incoming 304 and an outgoing 309 data handler component for receiving and transmitting information from and to the plurality of user system nodes 202, 400 and/or the application server nodes 204 via the network 230.

In an embodiment, the CRM system 300 includes a data store 321 for storing a plurality of data objects including a plurality of contact records 322, a plurality of event records 324, a plurality of account records 325, a plurality of correspondence records 326, and/or other records 327 (collectively “CRM records 320”). As used herein, a CRM record 320 can include, but is not limited to, a tuple corresponding to a person or user, a file, a case, a folder, an opportunity, a product, an account, an event, an interaction, and/or any data object. The CRM system 300 can include a data manager component 308 that can be configured to insert, delete, and/or update the records 320 stored in the data store 321. In addition, the CRM system 300 can include a monitoring agent 305 that is configured to monitor activities or interactions related to the CRM records 320. For example, the monitoring agent 305 can be configured to detect a user's post via a public or private social networking service 205, and/or a user's email client on the user's enterprise desktop computer, and to monitor updates to the contact records 322, event records 324, account records 325, and/or any other CRM record(s) 320 stored in the data store 321. In an embodiment, the monitoring agent 305 can be configured to create and/or update a correspondence record 326 when such an interaction is detected and to store the new or updated correspondence record 326 in the data store 321.

In an embodiment, the data store 321 can be a database system located in a cloud computing environment, and may be implemented as a multi-tenant database system. As used herein, the term multi-tenant database system refers to those systems in which various elements of hardware and software of the database system may be shared by one or more customers or enterprises. For example, a given application server 220 may simultaneously process requests for a great number of customers or enterprises, and a given database table may store rows for multiple customers or enterprises.

According to an embodiment, the execution environment 301, or an analog, provided by the CRM server node 220 can also include a CRM recommendation service 310. Alternatively, as is shown in FIG. 2, the CRM recommendation service 310 can be a component integrated with the CRM system 300. FIG. 3B is a block diagram illustrating an exemplary CRM recommendation service 310 according to an embodiment, which can be configured to receive information from the user system nodes 202, 400 and/or from the social networking entities 205, and to retrieve and provide information to the user system nodes 202, 400 via the network 230.

The network 230 can be a local area network (LAN) or a wide area network (WAN), such as the Internet. Each user system node 202, 400 may include an application that allows network communication between the user system 202, 400 and the CRM service 310 hosted by the application server 220. Such an application can be, in an embodiment, a web portal (not shown) provided by a network browser (e.g., Chrome, Internet Explorer, Safari, etc.) or the like that is capable of sending and receiving information to and from the application servers 204, 220.

FIG. 1A, as stated above, illustrates a method for providing information to a user system from a CRM system. In this case, the method 100 can be implemented in the context of the CRM server 220 hosting the CRM recommendation service 310, but can also be implemented in any desired environment. With reference to FIG. 1A, the method 100 begins, in block 102, by receiving a message from a requesting user system associated with a user. In an embodiment, the message includes a request for recommended information and real-time user-specific information collected by and stored on the requesting user system. The CRM recommendation service 310 includes a record handler component 314 configured to receive the message from the requesting user system 400 associated with a user 203.

In an embodiment, the real-time user-specific information 471 can comprise information collected and/or used by various client applications hosted by the requesting user system 400 and stored locally on the requesting user system 400. For example, real-time user-specific information 471 can include interaction information gathered from an email client, a telephone application, a social networking application, a web browser, and/or any number of messaging applications that allow the user 203 to interact with his contacts 201a, 201b or other entities, e.g., the social networking service 205. Accordingly, in an embodiment, the interaction information can include contact information associated with at least some of the user's contacts 201a, 201b, historical information relating to the user's business and personal interactions with the user's contacts 201a, 201b, messages posted to, sent to and received from the user's contacts 201a, 201b; telephone calls made to and received from the user's contacts 201a, 201b; and notifications associated with the user's contacts 201a, 201b received from one or more social networking services 205. In addition, the interaction information can also include information relating to the user's web browsing history, searches and/or downloads.

Alternatively or in addition, the real-time user-specific information 471 can include, in an embodiment, calendaring information gathered from one or more calendaring applications on the requesting user system 400. The calendaring information can include information relating to the user's past, pending, and future events, appointments, and meetings. In addition, the calendaring information can include reminders, task lists, and other information typically managed by a calendaring client on the requesting user system 400.

In another embodiment, the real-time user-specific information 471 can also include information collected from word processing and/or file system processing applications on the requesting user system 400. For example, such information 471 can include information relating to documents, files and/or objects recently opened, viewed, and/or modified by the user 203 on the requesting user system 400.

In addition or alternatively, the real-time user-specific information 471 can also include, in an embodiment, geo-location information associated with the requesting user system 400 gathered from a Global Positioning System (“GPS”) unit in the requesting user system 400. For example, the requesting user system 400 can be a handheld mobile device that includes a GPS unit that is configured to calculate the requesting user system's 400 location based on received satellite signals. The geo-location information can include, in an embodiment, latitude and longitude information associated with a location at a particular time. The geo-location information can also include correlated information related to the latitude and longitude information. For example, the correlated information can comprise an address, a business name and/or contact name associated with the address, and an identifier identifying the location. In an embodiment, the GPS unit in the requesting user system 400 can track and record the system's location periodically, e.g., every 10 minutes, and the geo-location information can include the current location of the system 400 when the message is sent, and previous recorded location(s) of the requesting user system 400.

According to an embodiment, the request for recommended information can include enterprise-specific information 481 in place of or in addition to the user-specific information 471. The enterprise-specific information 481 can comprise, in an embodiment, information stored on the requesting user system 400, e.g., as configuration data or as a default setting. Alternatively or in addition, the enterprise-specific information 481 can be provided by the user 203 via an input form or some other input document. In an embodiment, the information 481 can include information identifying the enterprise, a product name, a brand, information identifying an industry, and/or information identifying at least one competitor enterprise.

According to an embodiment, the record handler component 312 in the CRM recommendation service 310 is configured to receive the message from the requesting user system 400 over the network 230 via a network subsystem 302 and an application protocol layer, or other higher protocol layer, as illustrated by an exemplary HTTP protocol layer 303, among many possible standard and proprietary protocol layers. These higher protocol layers can encode, package, and/or reformat data for sending and receiving messages over a network layer, such as Internet Protocol (IP), and/or a transport layer, such as Transmission Control Protocol (TCP) and/or User Datagram Protocol (UDP). A request handler component 306 in the CRM system 300 can be configured to receive the message via the incoming data handler 304 and to route the message to the CRM recommendation service 310 for further processing.

Referring again to FIG. 1A, when the message including the request for recommended information is received, a plurality of accessible records related to the real-time user-specific information is identified in block 104. According to an embodiment, the user is authorized to access each of the identified accessible records, and each is managed by the CRM system 300. In an embodiment, the record handler component 312 in the CRM recommendation service 310 is configured to identify the plurality of accessible records related to the real-time user-specific information, wherein the user is authorized to access each of the plurality of accessible records and wherein each accessible record is managed by the CRM system 300. Similarly, when the message includes enterprise-specific information 481, the record handler component 312 is configured to identify a plurality of accessible records related to the enterprise-specific information 481.

In an embodiment, when the message from the requesting user system 400 is received, the record handler component 312 can be configured to extract the user-specific information 471 and/or the enterprise-specific information 481 from the message and to generate at least one search query for CRM records 320 relating to the user-specific 471 and/or the enterprise-specific 481 information. In an embodiment, the record handler component 312 can include a query manager 313 configured to generate and to submit the one or more search queries to the data manager component 308 in the CRM system 300, which can be configured to retrieve and return CRM records 320 satisfying the one or more search queries.

For example, when the user-specific information 471 includes interaction information comprising contact information associated with a user's contact, e.g., 201a, the query manager 313 can be configured to generate a search query based on the contact information, e.g., name, email address, company name, etc., and to submit the query to the data manager component 308. In response, the data manager component 308 can retrieve from the data store 321 and return to the record handler component 312 a contact record 322 and/or other records 320 satisfying the query. For instance, when the query is broad, e.g., “retrieve all records containing the contact's name,” the data manager 308 can retrieve a contact record 322 corresponding to contact information of the user's contact 201a, an event record 324 corresponding to a meeting to which the user's contact 201a is invited, another contact record 322 corresponding to messages posted to social networking websites by the user's contact 201a, and a record 327 corresponding to a document authored by the user's contact 201a.

In another example, when the user-specific information 471 includes calendaring information comprising information relating to a past, ongoing, or upcoming event, the query manager 313 can be configured to generate a search query based on the calendaring information, e.g., date and time, names of participants, subject of meeting, etc., and to submit the query to the data manager component 308. In an embodiment, the data manager 308 can retrieve CRM records 320 related to the calendaring information including an event record 324 corresponding to a meeting with a matching meeting subject and scheduled on a matching date and time, contact records 322 corresponding to the meeting participants, and records corresponding to an account 325 and/or an opportunity associated with the meeting, and files and/or documents presented during the meeting.

In another example, when the user-specific information 471 includes current and/or historic geo-location information associated with the requesting user system 400, the query manager 313 can be configured to generate a search query based on the geo-location information, e.g., date and time, geo-location coordinates, etc., and to submit the query to the data manager component 308. In an embodiment, the data manager 308 can retrieve CRM records 320 related to the geo-location information including contact records 322 corresponding to the user's contacts 201a, 201b located nearby, an event record 324 corresponding to an event occurring nearby, and records 320 corresponding to customers, vendors or services in the vicinity.

In another example, when the enterprise-specific information 481 includes information identifying a product of the enterprise, the query manager 313 can be configured to generate a search query based on the product name, and to submit the query to the data manager component 308. In response, the data manager component 308 can retrieve from the data store 321 and return to the record handler component 312 an account record 325 and/or other records 320 satisfying the query. For instance, when the query is broad, e.g., “retrieve all records containing the product's name,” the data manager 308 can retrieve a contact record 322 corresponding to contact information of a person who is affiliated with the product, an event record 324 corresponding to a meeting in which the product is discussed, and an account record 325 associated with the product.

In an embodiment, when the plurality of CRM records 320 related to the real-time user-specific 471 and/or the enterprise-specific 481 information are received, the record handler component 312 can be configured to determine which of the CRM records 320 the user 203 is authorized to access. For instance, in an embodiment, the record handler component 312 can apply a record access control policy 314 that defines a user's 203 access rights to each record 320 based on several control factors, such as record type, security level associated with the record 320, the user's 203 title, role, and/or department, and/or any other control factor. A record 320 that the user 203 is authorized to access is an accessible record 315. In an embodiment, when the record handler component 312 determines that the user 203 is unauthorized to access an identified CRM record 320, that record 320 is filtered out, i.e., eliminated from consideration, and can be discarded or returned to the data manager component 308.

According to an embodiment, when the record handler component 312 determines that the user 203 is authorized to access an accessible record 315, the record handler component 312 can be configured to determine, for each of the accessible records 315, a record identifier 331 identifying the accessible record 315. For example, the CRM system 300 typically provides and stores a record identifier 331 for and with each CRM record 320, and the record handler component 312 can be configured to extract the record identifier 331 from the CRM record 320 corresponding to the accessible record 315. In another embodiment, the record handler component 312 can be configured to generate a record identifier 331 and to associate the record identifier 331 with the accessible record 315.

In an embodiment, the record handler component 312 can be configured to transmit the extracted and/or generated record identifier(s) 331 of the accessible record(s) 315 to the requesting user system 400 of the user 203, so that the requesting user system 400 can easily track the accessible record(s) 315. For example, in an embodiment, the record handler component 312 can be configured to provide the record identifier(s) 331 of the accessible record(s) 315 to the outgoing data handler component 309 in the CRM system 300. The outgoing data handler 309 can be configured to build a message that includes at least one record identifier 331 of at least one accessible record 315, and to interoperate directly with the protocol layer of the network subsystem 302 or with an application protocol layer 303. The message including the record identifier(s) 331 can be transmitted as a whole or in parts via the network subsystem 302 over the network 230 to the requesting user system 400 associated with the user 203.

Alternatively or in addition, the record handler component 312 can be configured to associate the accessible record 315 with the user 203 so that, from that point forward, the record handler component 312 can be aware that the user 203 is interested in the accessible record 315. In an embodiment, for example, the record handler component 312 can be configured to store the record identifier(s) 331 of the accessible record(s) 315 as user information 330 associated with the user 203. According to an embodiment, the real-time user-specific information 471 can also be stored as user information 330. In addition, when appropriate, the record handler component 312 can be configured to associate an accessible record 315 with the enterprise so that, from that point forward, the record handler component 312 can be aware that the accessible record 315 is relevant to the enterprise. In an embodiment, for example, the record handler component 312 can be configured to store the record identifier(s) 331 of the accessible record(s) 315 as enterprise information 340 associated with the enterprise. According to an embodiment, the enterprise-specific information 481 can also be stored as enterprise information 340.

Referring again to FIG. 1A, once the plurality of accessible records 315 related to the real-time user-specific 417 and/or enterprise-specific 481 information has been identified, a relevance score for each of the plurality of accessible records 315 is determined based on a plurality of relevance factors in block 106. According to an embodiment, a relevancy score handler component 316 in the CRM recommendation service 310 can be configured to determine the relevance score for each of the plurality of accessible records 315, wherein the relevance score is based on a plurality of relevance factors.

According to an embodiment, the plurality of relevance factors 317 can be used to determine how, whether and to what extent an accessible record 315 is likely to be relevant to the user 203 and/or to the enterprise. For example, when the record 315 under consideration is a contact record 322 corresponding to a person, e.g., the user's contact 201a, a relevance factor 317 can be directed to a frequency with which the user 203 has interactions with the contact 201a associated with the contact record 322, i.e., how many times has the user 203 called, emailed, and/or texted the contact 201a. Alternatively, when the record 315 is an account record 325 representing a customer, competitor, and/or partner of the enterprise, a relevance factor 317 can be directed to an actual or potential amount of revenue generated by the customer, competitor, and/or partner. Another relevance factor 317 can be directed to a temporal proximity of an interaction with the contact 201a, i.e., how recent was the last interaction between the user 203/enterprise and the contact 201a/customer, a frequency with which the enterprise interacts with the customer, and/or whether the user 203 subscribes to, i.e., follows, the contact's 201a posts to social networking entities 205.

In another example, when the accessible record 315 under consideration is an event record 324 corresponding to an upcoming meeting, a relevance factor 317 can be directed to a temporal proximity of the meeting, i.e., how many minutes until a start time of the meeting. In addition, when the record 315 under consideration is one corresponding to a document or file, a relevance factor 317 can be directed to whether the user 203 owns, created and/or follows the document. Alternatively, when the document or file is associated with a meeting, a relevance factor 317 can be directed to when the meeting is scheduled to begin. In some or all of the examples, a relevance factor 317 can be directed to a location proximity of the record under consideration, i.e., how close in distance the requesting user system 400 is to the location of the record 315.

Other relevance factors 317 can be defined and directed to a variety of subjects. For example, a non-exhaustive list of relevance factors 317 for determining the relevance of an accessible record 315 from the perspective of the user 203 can be directed to:
whether the user has communicated recently with a record corresponding to a contact via the user's corporate social network
whether the user is discussing an object represented by the record in the user's corporate social network
whether a file or document represented by a record has been edited recently
a number of social interactions between the user and a contact associated with the record
how recently the user has viewed an object associated with a record
how recently the requesting user system has been near an object associated with a record
whether an object represented by a record is of a type with which the user typically interacts
   Similarly, a non-exhaustive list of relevance factors 317 for determining the relevance of an accessible record 315 from the perspective of the enterprise can be directed to:
how many contacts are associated with a record corresponding to an account and how frequently does the enterprise interact with those contacts
how many different types of products are sold by the enterprise to a customer associated with a record
whether and how many opportunities are pending with a company and/or contact associated with a record
how much potential revenue can be generated by an opportunity associated with a record
how much revenue has been generated from the sales of a product associated with a record
whether a company associated with a record is publicly traded or privately held
whether a contact associated with a record is an officer of an important account

According to another embodiment, the relevance score for each of the accessible records 315 can also be determined based on a plurality of social media influence factors (“influence factors”) 317a, which can be used to determine how, whether and to what extent an accessible record 315 is likely to be relevant to the user 203 and/or to the enterprise based on the record's social media activity. For example, when the accessible record 315 corresponds to a contact record 322 of a first user 201a, an influence factor 317a can be related to a number of following users 201b following the first user 201a via at least one social networking entity 205 because when the first user 201a is followed by, and/or friends with, tens of thousands of following users 201b who will potentially view the first user's posts, this fact can be an indication that the first user 201a is highly influential.

In an embodiment, another influence factor 317a can be related to a social and/or professional status or attribute of a following user 201b, i.e., who is following the first user 206a. For example, when a following user's professional status or attribute indicates that she is the chief executive officer (CEO) of a customer, this fact can be an indication that the first user 201a is highly influential because the customer's CEO is presumably interested in viewing the first user's posts. Another influence factor 317a can be directed to a number and/or a social and/or professional status/attribute of second degree users following the following user 201b, and whether a social media object 206a posted by the first user 210a is reposted by the following users 201b to their respective following users. For example, when a following user 201b is a film or music recording celebrity who is followed by millions of user fans, a social media object 206a posted by the first user 201a can potentially reach the millions of user fans when the celebrity following user 201b reposts the social media object 206a.

In another embodiment, an influence factor 317a can be related to reactions and comments to a social media object 206a posted by an accessible record 315. For example, the first user 201a can be considered relevant to the user 203 and/or the enterprise when social media objects 206 posted by the first user 201a generate numerous comments from following users 201b and/or numerous users indicate that they agree with, or have an affinity toward, the posted social media objects 206. In an embodiment, such a reaction can be submitted when a user “likes” the social media object 206a and/or “likes” a comment relating to the social media object 206a. In addition, another influence factor 317a can be directed to how many social media objects 206 relating to the user 203 and/or the enterprise have been posted by the record 315, e.g., the first user 201a. For example, when the first user 201a has posted hundreds of messages, images and audio/video clips relating to the user 203 and/or the enterprise, this fact can indicate that the first user 201a is highly relevant to the user 203 and/or the enterprise.

Other influence factors 317a can be defined and directed to a variety of subjects. For example, a non-exhaustive list of influence factors 317a can be directed to:
how frequently an entity associated with a record 315 posts social media objects relating to the user 203 and/or the enterprise;
how influential an entity associated with a record 315 is relative to a social networking entity 205
whether an entity associated with a record 315 posts social media objects 206 relating to rivals of the user 203 and/or the enterprise; and
other areas that can indicate whether and to what extent the record 315 is likely to be someone or something who shapes and/or controls how others perceive or relate to the user 203 and/or the enterprise.

In an embodiment, each relevance factor 317 and/or influence factor 317a can be weighted by a weighting factor to reflect its importance relative to the other relevance 317 and/or influence 317a factors. For example, a relevance factor 317 directed to how recently the user 203 printed a document can be weighted heavier than a relevance factor 317 directed to how recently the user 203 opened the document on a presumption that a printed document is more important to the user 203 than one that is merely opened by the user 203. In another example, a relevance factor 317 directed to how recently the enterprise has closed a support case with a customer can be weighted heavier than a relevance factor 317 directed to how recently the enterprise opened a support case with the customer on a presumption that a resolved case is more important to the enterprise than one that is merely opened.

In another example, when an influence factor 317a is directed to attributes of a record 315, e.g., a contact record 322 corresponding to a user 201a, the influence factor 317a can be weighted by a weighting factor based on those attributes, such as an identity of the user 201a, an occupation of the user 201a, a company with which the user 201a is affiliated, a title of the user 201a with respect to the company, and/or whether the company is an existing or prospective customer of the user 203 and/or enterprise. Accordingly, when the influence factor 317a is directed to the title of the user 201a, the weighting factor for the title of “executive buyer” can be greater than the weighting factor for the title of “mailroom personnel.”

In another embodiment, when an influence factor 317a is directed to attributes of a following entity, e.g., following user 201b, the influence factor 317a can be weighted by a weighting factor based on those attributes, such as an identity of a following user 201b, a relationship between the following user 201b and the first user 201a, an occupation of the following user 201b, a company with which the following user 201b is affiliated, a title of the following user 201b with respect to the company, and whether the company is one of an existing or prospective customer of the brand. Accordingly, when the influence factor 317a is directed to the relationship between the following user 201b user and the first user 201a, the weighting factor for a social relationship can be greater than the weighting factor for a professional relationship.

The weighting factor of a relevance 317 and/or influence 317a factor can be at least equal to one (1) and can be determined by an administrator or by default in an embodiment. Alternatively or in addition, the user 203 can provide the weighting factor of the relevance 317 and/or influence 317a factor to reflect the user's personal preferences.

In an embodiment, the relevancy score handler 316 can be configured to identify a subset of relevance factors 317 of the plurality of relevance factors 317 based on an attribute, e.g., record type, of an accessible record 315. For example, when a first accessible record 315 corresponds to a document, a subset of relevance factors 317 directed to documents can be identified for the first record 315. For example, such a subset can include a relevance factor 317 directed to whether the user 203 opened the document recently and a relevance factor 317 directed to the frequency with which the user 203 emails the record can be excluded from the subset. Similarly, subsets of influence factors 317a can also be identified based on attributes of accessible records 315. For example, when a first record 315 is of a first record type, e.g., a contact record 322 corresponding to a person, and a second record 315 is of a second record type, e.g., an account record 325 corresponding to customer, competitor, and/or partner, a first set of influence factors 317a directed to contact records 322 can be identified and a second set of influence factors 317a directed to account records 325 can be identified. When the subset is identified, the relevancy score handler 316 can be configured to disregard relevance 317 and/or influence 317a factors excluded from the subset, and to determine a raw score for the each of the relevance 317 and/or influence 317a factors in the subset.

Alternatively or in addition, the relevancy score handler 316 can be configured to identify another subset of relevance 317 and/or influence 317a factors based on a relevance type, such as socio-relevance and/or geo-relevance. As discussed above, relevance 317 and/or influence 317a factors can be used, in an embodiment, to determine how an accessible record 315 is relevant to the user 203 and/or the enterprise. Accordingly, a first subset of relevance 317 and/or influence 317a factors directed to the geo-location of the user system 400, of the enterprise, and/or of an accessible record 315 can be considered to determine a first raw score for the each of the relevance 317 and/or influence 317a factors in the first subset, and a second subset of relevance 317 and/or influence 317a factors directed to user and/or enterprise interactions can be considered to determine a second raw score for each of the factors 317, 317a in the second subset. In an embodiment, the first raw scores can be used to determine the geo-relevance of the accessible record 315 to the user 203 and/or to the enterprise, and the second raw scores can be used to determine the socio-relevance of the accessible record 315 to the user 203 and/or to the enterprise.

In an embodiment, the relevancy score handler component 316 can be configured to analyze each accessible record 315 in light of at least one of the plurality of relevance 317 and/or influence 317a factors, e.g., the factors 317, 317a in the subset, in order to determine a raw score for each relevance 317 and/or influence 317a factor. In an embodiment, each raw score can be derived at least in part from the real-time user-specific information 471, the enterprise-specific information 481, information stored in the CRM system 300 and/or information received from social networking entities 205.

According to an embodiment, a social media handler component 312a in the CRM recommendation service 310 can be configured to receive public real-time social networking data 207a relating to an accessible record 315 and/or social media objects 206a posted by the accessible record 315 from the social networking entities 205, and to analyze this data in light of at least one of the plurality of social media influence factors 317a. In an embodiment, the social networking data 207a can include, but is not limited to, professional and personal information identifying and pertaining to the record 315, information identifying entities following the record 315, and entities followed by the record 315. Social media objects 206 can include text objects, and video, audio and image objects, and reactions and comments relating to such posted objects.

In an embodiment, a relevance 317 and/or influence 317a factor can be treated as a question relating to the accessible record 315, and a raw score for the factor 317, 317a can be determined based on an answer to the question. For instance, a relevance factor 317 that is directed to a location proximity of a contact 201a associated with an accessible record 315 can be treated as the question, “How close is this contact 201a to me?” The relevancy score handler component 316 can be configured to answer this question based at least in part on the real-time user-specific information 471 that indicates the current geo-location of the requesting user system 400 and the location information associated with the contact 201a included in the accessible record 315.

In an embodiment, the raw score for a factor 317, 317a can be a value between a minimum value, e.g., zero (0), and a maximum value, e.g., ten (10). The minimum value can indicate a low level of relevancy and the maximum value can indicate a high level of relevancy between the user 203 or enterprise and the record 315 according to this particular relevance 317 and/or influence 317a factor. Accordingly, referring to a previous example, when the number of interactions between the user 203 and the contact 201a during the preceding seven (7) days is zero, the determined raw score for a relevance factor directed to the frequency with which the user 203 interacts with the contact 201a can be the minimum value, indicating that the contact 201a is not relevant to the user 203 based on this relevance factor 317. Alternatively, when the number of interactions is high, e.g., above a threshold set by the user 203 or by default, the determined raw score can be the maximum value, indicating that the contact 201a is relevant to the user 203 based on this relevance factor 317. In an embodiment when the relevance 317 and/or influence 317a factor is weighted by a weighting factor, e.g., defined by an administrator and/or by the user 203, the determined raw score can be multiplied by the weighting factor to generate a weighted raw score for the relevance 317 and/or influence 317a factor.

According to an embodiment, once the raw score and/or the weighted raw score for each relevance 317 and/or influence 317a factor considered is determined, the relevancy score handler 316 can be configured to determine the relevance score 332, 342 for the accessible record 315 by accumulating the raw and/or weighted raw scores to generate a sum of the raw and/or weighted raw scores. In an embodiment, the sum of the raw and/or weighted raw scores is the relevance score 332, 342 for the accessible record 315 and indicates the relevance of the accessible record 315 to the user 203 or to the enterprise.

According to an embodiment, the relevancy score handler 316 can be configured to determine more than one relevance score 332, 342 for the accessible record 315. For example, in an embodiment, an overall relevance score 332, 342 can be determined based on the sum of the raw and/or weighted raw scores for each of the plurality of relevance 317 and/or influence 317a factors. Alternatively or in addition, a specialized relevance score 332, 342 can be determined based the sum of the raw scores for a subset of factors 317, 317a. For example, as described above, a first subset of factors 317, 317a can be directed to the geo-location of the user system 400 or enterprise and/or of an accessible record 315. In this case, a geo-relevance score 332, 342 can be determined based on the sum of the raw and/or weighted scores for the factors 317, 317a in the first subset. Alternatively, a second subset of relevance 317 and/or influence 317a factors can be directed to user/enterprise interactions, and a socio-relevance score 332, 342 can be determined based on the sum of the raw and/or weighted raw scores for the relevance 317 and/or influence 317a factors in the second subset. In an embodiment, the geo-relevance score 332, 342 and the socio-relevance score 332, 342 indicate the geo-relevance and the socio-relevance, respectively, of the accessible record 315 to the user 203 or the enterprise. In an embodiment, the relevance score 332 relative to the user 203 for the record 315 can be different from the relevance score 342 relative to the enterprise for the record 315. The relevance score handler component 316 can be configured, in an embodiment, to store the relevance scores 332, 342, e.g., the overall relevance score and/or the specialized relevance scores, for the accessible records 315 as user information 330 or enterprise information 340.

Referring again to FIG. 1A, once the relevance score(s) 332, 342 for each of the accessible records 315 is determined, at least one recommended record is selected from the plurality of accessible records 315, in block 108, based on the relevance score 332, 342 of the recommended record(s). According to an embodiment, the relevancy score handler component 316 in the CRM recommendation service 310 can be configured to select at least one recommended record 318 from the plurality of accessible records 315 based on the relevance score 332, 342 of the at least one recommended record 318.

According to an embodiment, the relevancy score handler component 316 can be configured, in an embodiment, to select a recommended record 318 by identifying an accessible record 315 having a relevance score 332, 342 greater than a predetermined relevancy threshold value. The relevancy threshold value can be a default value set by an administrator in an embodiment. Alternatively or in addition, the relevancy threshold value can be a value defined by the user 203 and/or by the enterprise, and stored as a user preference 333 with the user information 330 and/or as an enterprise preference with the enterprise information 340.

In an embodiment, more than one relevancy threshold value can be applied. For example, the relevancy score handler component 316 can be configured to apply the default threshold value on a first pass over the accessible records 315 and depending on how many accessible records 315 are identified, can apply the user defined threshold value to filter accessible records 315 from or add accessible records 315 to the group of identified records 318. Alternatively or in addition, a first relevancy threshold value can be applied for accessible records 315 relevant to the user 203, and a second threshold value can be applied for accessible records 315 relevant to the enterprise. In an embodiment, the first and second threshold values can be the same, or in another embodiment, they can be different.

In another embodiment, the relevancy score handler component 316 can be configured to select at least one recommended record 318 from the accessible records 315 by generating a sorted list comprising the accessible records 315 sorted by their respective relevance scores 332, 342. In an embodiment, the accessible records 315 can be sorted in an order from highest score 332, 342 to lowest score 332, 342, i.e., most relevant to least relevant. Once the sorted list is generated, the relevancy score handler component 316 can be configured to select a predetermined number of accessible records 315 from the sorted list, e.g., the top five (5) records, to be the at least one recommended record 318. In an embodiment, the predetermined number can be a default value set by the administrator or a value defined by the user 203 and stored as a user preference 333 with the user information 330.

In another embodiment, the relevancy score handler component 316 can be configured to select at least one recommended record 318 from the accessible records 315 based on both the predetermined number and the relevancy threshold value. For example, the relevancy score handler component 316 can generate the list of accessible records 315 sorted by relevance score 332, 342 and can identify the top ten (10) accessible records 315 from the list. The relevancy score handler component 316 can then select the recommended records 318 by selecting from the identified top ten (10) records 315 accessible records that have relevance scores 332, 342 exceeding the relevance threshold value(s).

According to an embodiment, the relevancy score handler component 316 can also generate a list of accessible records 315 sorted by their geo-relevance score 332, 342 and/or a list of accessible records 315 sorted by their socio-relevance score 332, 342. From either or both of these lists, the relevancy score handler component 316 can select recommended records 318 based on their geo-relevance or socio-relevance to the user 203 and/or the enterprise, as well as based on their overall relevance to the user 203 and/or the enterprise. Alternatively or in addition, the relevancy score handler component 316 can generate a list of accessible records 315 sorted by their record type, and recommended records 318 of a particular type can be selected. For example, the accessible records 315 can be sorted by record type, e.g., contact records 322 and account records 325, into lists of record types, and the relevancy score handler component 316 can select recommended records 318, e.g., contact records 322 and account records 325, from each list based on their relevance scores 332, 342.

Referring again to FIG. 1A, in block 110, once the at least one recommended record 318 is selected, a response message including information identifying the at least one recommended record 318 is transmitted to the requesting user system 400 associated with the user 203. According to an embodiment, a list handler component 319 in the CRM recommendation service 310 is configured to transmit a first response message 334 including information identifying the at least one recommended record 318 to the requesting user system 400.

As stated above, in an embodiment, when the accessible records 315 are determined from the plurality of identified records 320, the record identifiers 331 identifying the accessible records 315 can be stored as user information 330 in the CRM recommendation service 310. According to an embodiment, when a recommended record(s) 318 is selected, the list handler component 319 can be configured to receive the recommended record(s) 318 from the relevancy score handler component 316 and to retrieve the record identifier(s) 331 identifying the recommended record(s) 318. Alternatively or in addition, the record identifiers 331 can be extracted from the accessible records 315 that have been selected as recommended records 318.

According to an embodiment, the list handler component 319 can be configured to generate a ranked list 335 comprising the record identifiers 331 identifying the recommended records 318. In an embodiment, the ranked list 335 can rank the record identifiers 331 by the relevancy scores 332, 342 of the recommended records 318 in an order from highest score 332, 342 to lowest score 332, 342, i.e., most relevant to least relevant. Additionally, the ranked list 335 can include the relevance scores 332, 342 along with the associated record identifiers 331 identifying the recommended records 318

As described above, the recommended records 318 can be selected based on their particular record type and/or particular relevancy, e.g., geo-relevance or socio-relevance, to the user 203 and/or to the enterprise. In an embodiment, the list handler component 319 can be configured to generate at least one specialized ranked list 335 based on a record type and/or a relevance type. For example, the list handler component 319 can be configured to generate a geo-relevance ranked list 335 and/or a socio-relevance ranked list 335 comprising record identifiers 331 identifying the geo-relevant and/or socio-relevant recommended records 318, respectively. Alternatively or in addition, a ranked list 335 corresponding to a particular record type can be generated that comprises information identifying the recommended records 318 of that particular record type that are relevant to the user 203 and/or the enterprise. For example, a first ranked list 335 can be generated for contact records 322 corresponding to people and a second ranked list 335 can be generated for account records 325 representing customers, competitors, and/or partners of the enterprise. The first ranked list 335 can include information identifying at least one person relevant to the user 203 and/or the enterprise and the second ranked list 335 can include information identifying at least one account relevant to the user 203 and/or the enterprise.

The list handler component 319 can be configured, in an embodiment, to build the first response message 334 and to include the information identifying the recommended records 318, e.g., the identifiers 331 and/or the ranked list(s) 335, and to provide the first response message 334 to the outgoing data handler 309 in the CRM system 300. In an embodiment, the outgoing data handler 309 can be configured to interoperate directly with the protocol layer of the network subsystem 302 or with the application protocol layer 303. The message 334 including the identifying information, e.g., the ranked list(s) 335, can be transmitted as a whole or in parts via the network subsystem 302 over the network 230 to the requesting user system 400 associated with the user 203.

FIG. 1B illustrates a method for presenting recommended information from a CRM system according to an embodiment. Here, the method 150 can be implemented in the context of the requesting user system 400 of FIG. 2. The method 150 may, however, be carried out in any desired environment.

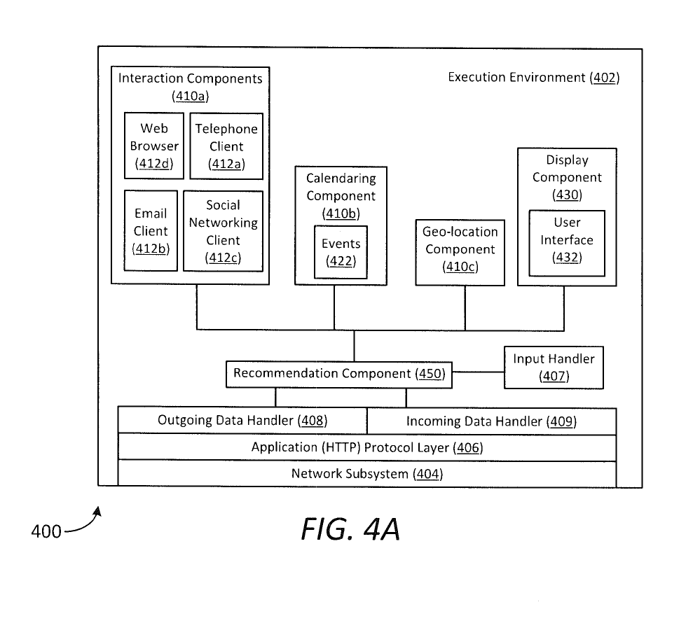

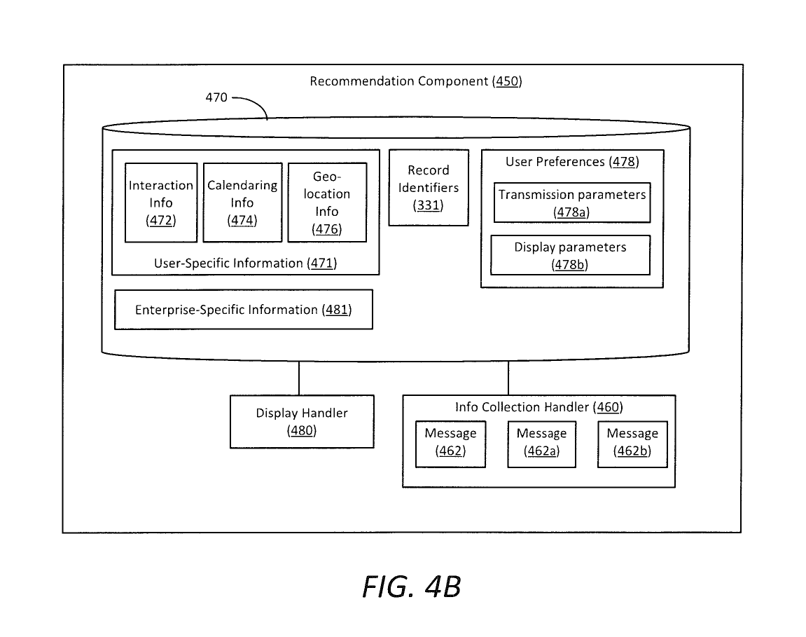

FIG. 4A is a block diagram illustrating an exemplary system for presenting recommended information from the CRM system 300. In an embodiment, the components illustrated in FIG. 4A are configured to operate within an execution environment hosted by a physical or virtual computer node and/or multiple computer nodes, as in a distributed execution environment. According an embodiment, the requesting user system 400 can be configured to provide an execution environment 402 configured to support the operation of the components illustrated in FIG. 4A and/or their analogs.

In an embodiment illustrated in FIG. 4A, the user system 400 hosts at least one component or application that supports user-specific functions. For example, the user system 400 can include interaction components 410a that allow the user 203 to interact or communicate over the network 230 with other contacts 201a, 201b and/or services, such as web services or social networking services 205. Interaction components 410a can include, but are not limited to, a telephone client application 412a, an email client application 412b, a social networking client application 412c, and a web browser application 412d. The user system 400 can also include a calendaring component 410b that allows the user 203 to calendar events 422, e.g., meetings, tasks, deadlines, etc., and a geo-location component 410c that tracks and/or maps the user system's current and/or historical geo-location information. Other components 410 or applications 412 that support user-specific functions are available, e.g., book reading components and music components, and therefore the components 410 and applications 412 supported by the user system 400 are not limited to those illustrated and/or described above.

In an embodiment, each component 410a-410c or application 412a-412d can be configured to track user-specific information associated with the component 410a-410c or application 412a-412d, and to store the information in a storage block (not shown) associated with the component 410a-410c or application 412a-412d. For example, a typical telephone client application 412a can track calls made and received by the user system 400, and information identifying callers, i.e., contacts 201a, 201b. This user-specific information can be stored in a call log (not shown) associated with the telephone client 412a. A typical email client application 412b can track messages sent and received by the user system 400, and information identifying recipients and senders, and can store this user-specific information in at least one folder or message log (not shown) associated with the email client 412b. Similarly, the social networking client application 412c can track the social networking activity of contacts 201a, 201b the user 203 is following, and can store the activity in an social networking activity log (not shown) associated with the social networking client 412c. Similarly, the calendaring component 410b can track scheduled events 422 and event details, and the geo-location component 410c can track the location of the user system 400 over time and location searches received, and each component can store this user-specific information in one or more storage blocks associated with the calendaring component 410b and/or the geo-location component 410c.

In an embodiment, the user system 400 can also include a display component 430 configured for displaying content to the user 203 on a user interface 432. In addition, the user system 400 can include incoming 409 and outgoing 408 data handler components for receiving and transmitting information from and to other user system nodes 202, servers 204, and the CRM server 220 via the network 230.

According to an embodiment, the execution environment 402 provided by the user system 400 includes a recommendation component 450. FIG. 4B is a block diagram illustrating an exemplary recommendation component 450 according to an embodiment. As is shown, the recommendation component 450 can include components adapted for operating in the execution environment 402, and can be configured to implement the method 150 of FIG. 1B.

Referring to FIG. 1B, FIG. 4A and FIG. 4B, an indication to request recommended records from the CRM system 300 is received in block 152. In an embodiment, an input handler component 407 in the user system 400 can be configured to receive the indication to request recommended records from the CRM system 300, and to transmit the indication to the recommendation component 450. The request can be for recommended records relevant to the user 203 in an embodiment, and/or relevant to another entity, such as an enterprise, in another embodiment. The user 203 can explicitly select one or both options, or one can be selected by default. For example, unless otherwise instructed, the received indication includes a request for recommended records relevant to the user 203.

The indication can be received in a number of ways. For example, it can be received via explicit input by the user 203 using an input device such as a keyboard or touch screen, via audio input, and/or via a scanning or imaging device. In another embodiment, the recommendation component 450 can receive the indication to request recommended records from a trigger (not shown) in the user system 400 that is configured to invoke the recommendation component 450 when certain triggering events are detected. For example, in an embodiment, a triggering event can be the activation of the user system 400, and/or opening or closing an application 412. Alternatively or in addition, the triggering event can be based on a specified time and/or a specified time period.

According to an embodiment, when the indication to request recommended records is received by the recommendation component 450 for a first time, the recommendation component 450 can execute a configuration routine to request and receive user preferences 478 from the user 203. In an embodiment, the configuration routine can include requesting and receiving user preferences 478 identifying from which components 410a-410c or applications 412a-412d the recommendation component 450 has permission to collect user-specific information. The recommendation component 450 can, in an embodiment, scan the user system 400 to identify the components 410a-410c or applications 412a-412d supporting user-specific functions. For each identified component, e.g., the calendaring component 410b, and application, e.g., the telephone client application 412a, the recommendation component 450 can request permission from the user 203 to collect user-specific information 471 associated with the identified component 410b and/or application 412a. In an embodiment, the recommendation component 450 can be configured to display to the user 203 via the user interface 432 the identified component 410b and/or application 412a, and can be configured to receive an indication from the user 203 granting or denying permission to collect user-specific information 471 from the component 410b and/or application 412a.

Accordingly, for example, the user 203 can grant permission to the recommendation component 450 to collect user-specific information 471 from the telephone client 412a, the email client 412b, and the calendaring component 410b, and can prevent the recommendation component 450 from collecting user-specific information from the social networking client 412c, the web browser 412d, and the geo-location component 410c. In another embodiment, the permission control feature can be disabled and the recommendation component 450 can be permitted to collect information from all identified components 410a-410c or applications 412a-412d supporting user-specific functions without exception.

According to another embodiment, the configuration routine can include receiving user preferences 478 relating to transmission parameters 478a for the user-specific information associated with the components 410a-410c or applications 412a-412d. In an embodiment, the transmission parameters 478a can define how much and/or what types of user-specific information 471 is transmitted to the CRM server 220. For example, in an embodiment, the transmission parameters 478a can define how many recent emails, telephone calls, posts, and web pages collected from the interaction components 410a to transmit to the CRM server 220. In addition, the transmission parameters 478a can indicate a time period from which calendaring information, e.g., scheduled events 422 and event details, are transmitted to the CRM server 220.

Moreover, in an embodiment, the transmission parameters 478a can indicate which types of interaction information 472, calendaring information 474, and/or geo-location information 476 to transmit to the CRM server 220. For example, the user 203 can indicate that interaction information 472 relating only to professional or business contacts, calendaring information 474 relating only to business and/or work events, and/or geo-location information 476 relating to locations in a certain region, can be transmitted to the CRM server 220.

In addition or alternatively, the configuration routine can include receiving user preferences 478 relating to display parameters 478b for displaying information relating to recommended CRM records. In an embodiment, the display parameters 478b can define how much and/or what type of information to display on the user interface 432 of the user system 400. In an embodiment, when the user preferences 478, e.g., the transmission parameters 478a and the display parameters 478b, are received, the recommendation component 450 can be configured to store the user preferences 478 in a local data store 470 associated with the recommendation component 450.

In addition, in an embodiment, the configuration routine can include receiving CRM user preferences 333 from the user 203 that can determine how many and which types of recommended records 318 to retrieve from the CRM system 300. For example, the user 203 can define weighting factors of relevance 317 and/or influence 317a factors to reflect the relative importance of some relevance and/or influence 317a factors to others, can define a threshold value, e.g., the relevancy threshold value, for selecting recommended records 318 from the accessible records 315, and/or can define the number of records selected from the sorted list of accessible records 315. In an embodiment, the CRM user preferences 333 can be transmitted to the CRM server 220, where they are stored as user information 330 associated with the user 203 by the CRM recommendation service 310.

Referring again to FIG. 1B, in response to receiving the indication to request recommended records, real-time user-specific information stored on the user system 400 is collected in block 154. In an embodiment, an information handler component 460 in the recommendation component 450 hosted by the user system 400 is configured to collect real-time user-specific information 471 stored on the user system 400 in response to receiving the indication to request recommended CRM records.

According to an embodiment, when the indication to request recommended records is received and transmitted to the recommendation component 450, the recommendation component 450 can be configured to invoke the information collection handler component 460. Once invoked, the information collection handler component 460 can be configured to access the storage blocks associated with the components 410a-410c or applications 412a-412d supporting user-specific functions, assuming it is permitted to, and to collect real-time user-specific information associated with the components 410a-410c or applications 412a-412d. As stated above, the real-time user-specific information 471 collected can include interaction information 472 from the interaction components 410a, calendaring information 474 from the calendaring component 410b, and/or geo-location information 476 from the geo-location component 410c. The user-specific information 471 can also include other types of information from other components 410 or applications 412, such as word processing and/or file system processing applications (not shown), and is not limited to that described above.

In an embodiment, when the information collection handler component 460 is invoked for the first time, the information collection handler component 460 can be configured to collect the user-specific information, e.g., interaction information 472, from a component, e.g., the interaction components 410a, and to store a copy of the information 472 in the local data store 470. Thereafter, when the information collection handler component 460 is invoked and collects the user-specific information from the components 410 and applications 412, the information collection handler component 460 can be configured to compare the existing user-specific information 471 stored in the data store 470 to the newly collected user-specific information to determine new user-specific information, e.g., new messages and new contacts, collected for a first time. In an embodiment, the new user-specific information can be added to the existing user-specific information 471 stored in the data store 470.

Alternatively or in addition, when the request is for recommended records relevant to an enterprise, the information collection handler component 460 can be configured to collect enterprise-specific information 481 from the user 203 and/or from local storage. For example, in an embodiment, a form page can be presented to the user 203 via the user interface 432, and the user 203 can enter enterprise-specific information via the form. Alternatively or in addition, enterprise-specific information 481 can be provided by a system administrator and stored in the data store 470. For example, the user system 400 can be associated with the enterprise and, as part of a setup procedure, the system administrator can provide the enterprise-specific information 481 to be stored in the data store 470. As stated above, the enterprise-specific information 481 can include information identifying the enterprise, a product name, a brand, information identifying an industry, and/or information identifying at least one competitor enterprise.

Referring again to FIG. 1B, when the real-time user-specific information 471 stored on the user system 400 and/or the enterprise-specific information 481 is collected, a message including a request for recommended CRM records and at least a portion of the real-time user-specific information and/or enterprise-specific information is transmitted to the CRM server 220 hosting the CRM recommendation service 310 in block 156. In an embodiment, the information handler component 460 can be configured to transmit a message 462 including a request for recommended CRM records and at least a portion of the real-time user specific information 471 and/or the enterprise-specific information 481 to the CRM server 220 hosting the CRM recommendation service 310. According to an embodiment described above, the CRM recommendation service 310 is configured to identify a plurality of accessible CRM records 315 related to the real-time user specific information 471 and/or the enterprise-specific information 481, and to identify at least one recommended CRM record 318 from the plurality of identified accessible CRM records 315 based on a relevance score 332, 342 of the at least one recommended CRM record 318.

According to an embodiment, when the request is for records relevant to the user 203, the information handler component 460 can be configured to build the message 462 and to determine at least a portion of the real-time user-specific information 471 collected from the user system's components 410 and applications 412 to include in the message 462. In an embodiment when new user-specific information, e.g., new messages and new contacts, is collected, the information handler component 460 can be configured to include at least a portion of the new real-time user-specific information 471 in the message 462. In addition or alternatively, in an embodiment, the information handler component 460 can be configured to determine what user-specific information 471 is included based on the user preferences 478 submitted by the user 203 during the configuration routine.

For example, the information handler component 460 can, in an embodiment, apply the transmission parameters 478a to filter the real-time user-specific information 471 in order to determine what user-specific information 471 is included in the message 462. As stated above, the transmission parameters 478a can define how much and/or what types of user-specific information 471 is transmitted to the CRM server 220. For example, in an embodiment, the transmission parameters 478a can define how many recent emails, telephone calls, posts, and web pages collected from the interaction components 410a to transmit to the CRM server 220. In addition, the transmission parameters 478a can indicate which types of interaction information 472, calendaring information 474, and/or geo-location information 476 to transmit to the CRM server 220. The information handler component 460 can be configured to apply the transmission parameters 478a to the newly collected and/or existing stored user-specific information 471 to identify information satisfying at least one of the transmission parameters 478a, and to include that information in the message 462.

Alternatively or in addition, when the request is for records relevant to the enterprise, the information handler component 460 can be configured to build another message 462a and to include at least a portion of the enterprise-specific information 481 collected from the user 203 and/or retrieved from the data store 470.

Once the message 462, 462a is built, the information handler component 460 can be configured, in an embodiment, to provide the message 462, 462a to the outgoing data handler 408 in the user system 400. In an embodiment, the outgoing data handler 408 can be configured to interoperate directly with a protocol layer of a network subsystem 404 or with an application protocol layer 406. The message 462, 462a including the request and user-specific information 471 and/or enterprise-specific information 481 can be transmitted as a whole or in parts via the network subsystem 404 over the network 230 to the CRM server 220 hosting CRM system 300.

As described above, when the message 462, 462a is transmitted to the CRM server 220, the record handler component 312 in the CRM recommendation service 310 can be configured to receive the message 462, 462a, and to identify accessible CRM records 315 related to the real-time user-specific information 471 and/or enterprise-specific information 481 in the message 462, 462a. For example, when the user-specific information 471 includes interaction information 472, the accessible record 315 related to the interaction information 472 can be a contact record 322 corresponding to a contact 201a of the user 203. In addition, when the user-specific information 471 includes calendaring information 474, the accessible record 315 related to the calendaring information 474 can be an event record 324 corresponding to an event 422. As described above, when an accessible record 315 is determined, the record handler component 312 can retrieve a record identifier 331 identifying the contact record 322 or the event record 324, and transmit it to the user system 400 in a message.

According to an embodiment, the information collection handler component 460 in the recommendation component 450 hosted by user system 400 can receive the message including the record identifier 331 identifying the contact record 322 or the event record 324 via the incoming data handler component 409. In an embodiment, the information collection handler component 460 can be configured to associate the record identifier 331 with the corresponding contact 201a in the interaction information 472 or the corresponding event 422 in the calendaring information 474. By associating the record identifier 331 with the corresponding contact 201a or event 422, the recommendation component 450 can determine which contacts e.g., 201a, or events 422 are managed by the CRM system 300 and which contacts, e.g., 201b, or events 422 are not. Accordingly, for future requests, the user-specific information 471 associated with a record identifier 331 can be included in the message 462 and user-specific information not associated with a record identifier 331 can be excluded because the CRM system 300 is not managing CRM records 320 corresponding to that information.

According to an embodiment, when the CRM recommendation service 310 identifies at least one recommended record 318 in a manner described earlier, a first response message 334 including information identifying the recommended records 318 is transmitted to the requesting user system 400. Referring again to FIG. 1B, the first response message 334 including information identifying the at least one recommended CRM record 318 is received from the CRM server 220 in block 158. In an embodiment, a display handler component 480 in the recommendation component 450 can be configured to receive the first response message 334 via the incoming data handler 409 in the user system 400. In an embodiment, when the first response message 334 is received, the display handler component 480 can be configured to display at least a portion of the information identifying the at least one recommended CRM record 318 on a user interface 432 of the user system 400 in block 160.

According to an embodiment, the first response message 334 can include one or more ranked lists 335 comprising record identifiers 331 identifying the recommended records 318 and optionally their respective relevance scores 332, 342. When the first response message 334 is received, the display handler component 480 can be configured to extract the list(s) 335 and the information identifying the recommended records 318 and to determine, in an embodiment, what portion of the information to display to the user 203 on the user interface 432.

For example, according to an embodiment, the display handler component 480 can apply the display parameters 478b to filter the information included in the first response message 334 in order to determine what information is displayed to the user 203. As stated above, the display parameters 478b can define how much and/or what type of information to display on the user interface 432 of the user system 400. For example, in an embodiment, the display parameters 478b can define how many recommended records 318 to display depending on the ranked list 335 on which the recommended records 318 are listed. In addition, the display parameters 478b can indicate which types of interaction information 472, calendaring information 474, and/or geo-location information 476 relating to the recommended records 318 to display. The display handler component 480 can be configured to apply the display parameters 478b to the information included in the first response message 334 to identify information satisfying at least one of the display parameters 478b. Once identified, the information can be provided to the display component 430, which can be configured to render the information for display on the user interface 432.

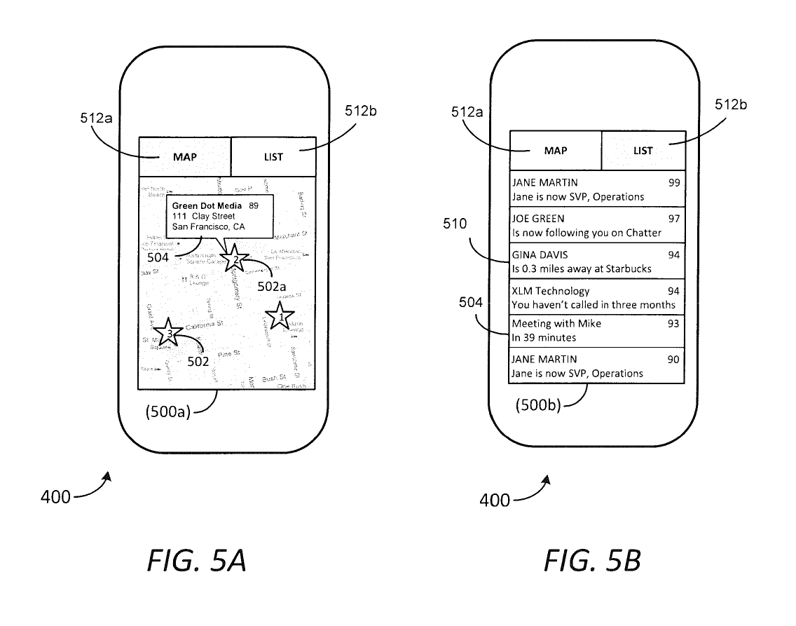

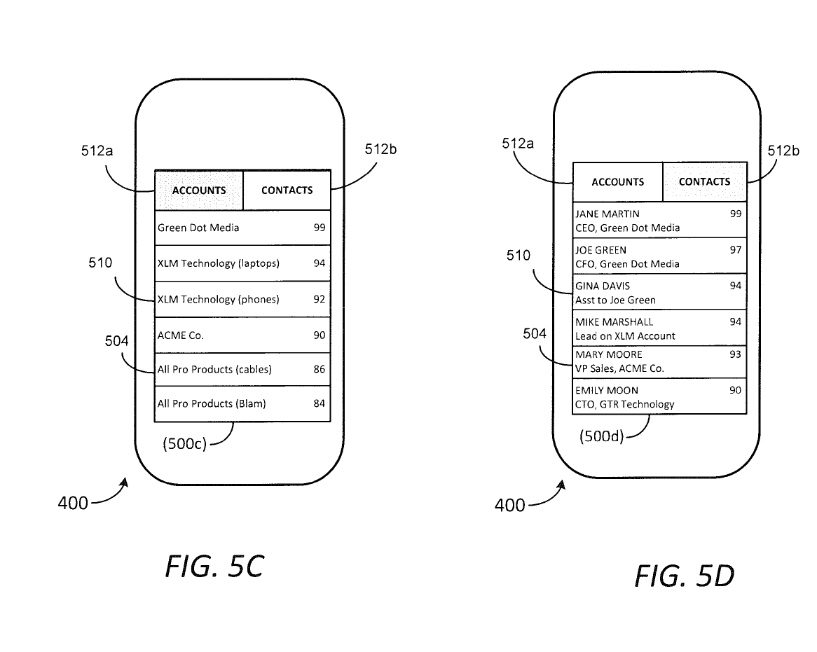

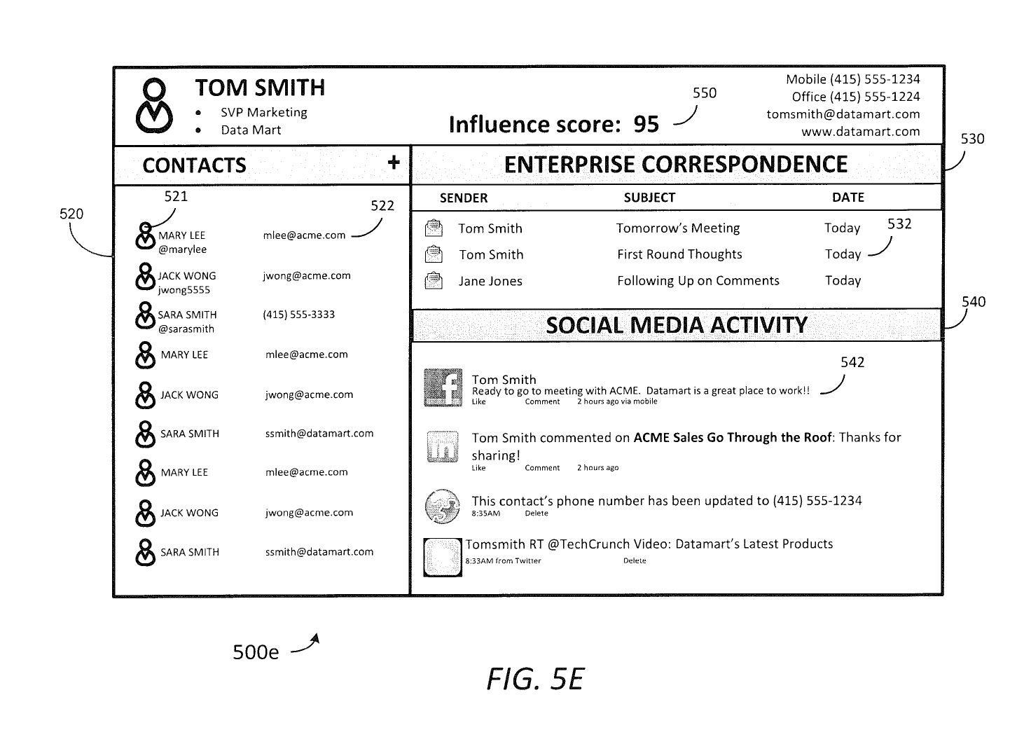

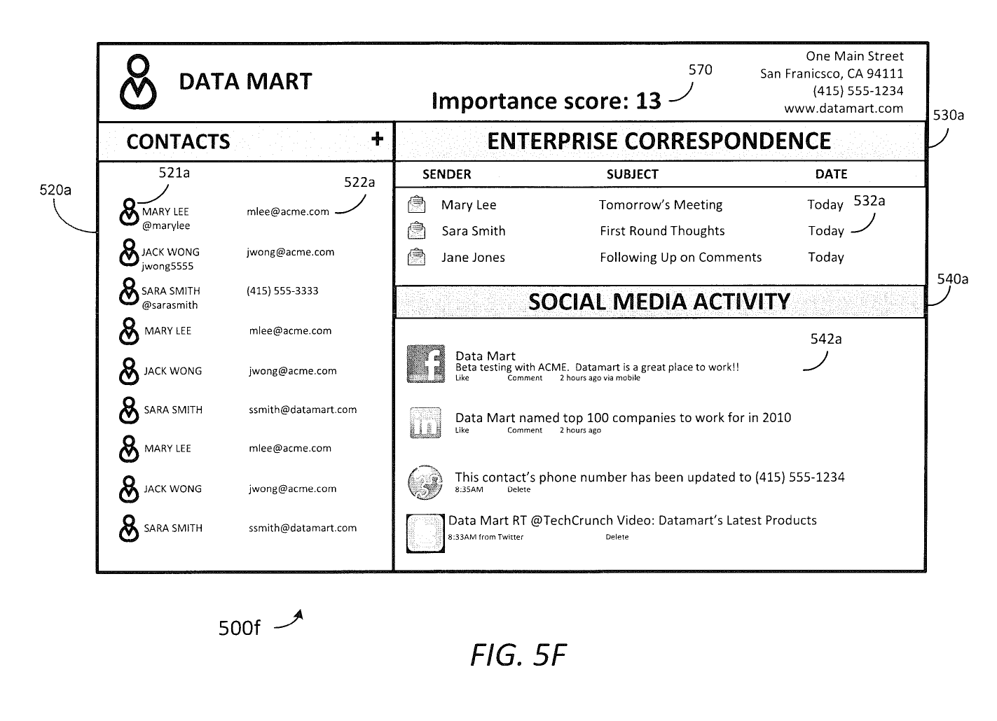

According to an embodiment, the display component 430 can be configured to render the information in a number of formats suiting the information. For example, in FIG. 5A, the display component 430 can present on the user interface 432 a map 500a that includes the information identifying the recommended records 318 represented as icons 502 located on the map 500a. For example, an icon 502a can represent a business, e.g., Green Dot Media, located on the map 500a on Clay Street. In an embodiment, contextual information 504 about the recommended record 318 can be displayed when the user 203 selects the icon 502. The contextual information 504 can include the name and location of the recommended recorded 318 and the relevance score 332, 342.

In another embodiment, illustrated in FIG. 5B, the display component 430 can present on the user interface 432 a list 500b that includes entries 510 for the information identifying the recommended records 318. According to an embodiment, each entry 510 can represent each recommended record 318 and can include the record's name and the contextual information 504 about the record. For example, when the record is a contact record 322 corresponding to a person, e.g., “Jane Martin,” the contextual information 504 can indicate the person's title and company, and when the record is an event record 324 corresponding to a meeting, e.g., “Meeting with Mike,” the contextual information 504 can indicate when the event is scheduled. According to an embodiment, the user 203 can toggle between the list view 500b shown in FIG. 5B and the map view 500a shown in FIG. 5A. For example, the user interface 432 can display a map button 512a, which when selected presents the map view 500a, and a list button 512b, which when selected presents the list view 500b.

In another embodiment, illustrated in FIG. 5C and FIG. 5D, the display component 430 can present on the user interface 432 a list 500c, 500d that includes entries 520 for the information identifying the recommended records 318 of a particular record type, e.g., account records 325 or contact records 322. In FIG. 5C and FIG. 5D, recommended records 318 corresponding to account records 325 and contact records 322, respectively, that are relevant to the user 203 and/or to the enterprise can be listed in an order based on each record's relevance score 332, 342. According to an embodiment, the user 203 can toggle between the account view 500c shown in FIG. 5C and the contacts view 500d shown in FIG. 5D. For example, the user interface 432 can display an accounts button 522a, which when selected presents the accounts view 500c, and a contacts button 522b, which when selected presents the contacts view 500d.

In either case, the user 203 is presented with information relevant and important to the user 203 based on at least a portion of the user-specific information 471 stored on the user's user system 400 and/or information relevant to the enterprise based on enterprise-specific information 481. The recommended information is presented to the user 203 with little or no input from the user 203 because when the recommendation component 450 is launched explicitly by the user 203 or automatically by the user system 400, the user-specific information 471 and/or enterprise-specific information 481 is collected automatically and transmitted to the CRM recommendation service 310 hosted by the CRM server 220, which automatically determines and returns the recommended records 3118 based on the user-specific information 471 and/or enterprise-specific information 481.

In some circumstances when a record 322, 325 relevant to the enterprise is displayed to the user 203, e.g., in the accounts 500c or contacts 500d list illustrated in FIG. 5C or FIG. 5D, the user 203 can be unfamiliar with an account 325 or a contact 322 because the record is relevant to the enterprise and not necessarily to the user 203. According to an embodiment, the user 203 can request information relating to a recommended record 318, e.g., a contact 322 or an account 325, by selecting an entry 520a corresponding to the recommended record 318 of interest. The input handler 407 can receive the user's selection and route it to the information handler component 460, which can extract the information identifying the record 318 from the selected entry 520a. In another embodiment, the user 203 can provide information identifying any entity of interest, such as for example, a person, a product, an account, or an enterprise directly to the information handler component 460, e.g., via a dialogue box or a window.

In an embodiment, the information handler 460 can build a message 462b that includes a request for information relating to the record 318 corresponding to the selected entry 520a or relating to the entity of interest, and that also includes information identifying the record 318 and/or the entity of interest. Once the message 462b is built, the information handler component 460 can be configured, in an embodiment, to provide the message 462b to the outgoing data handler 408, which is configured to transmit the message 462b as a whole or in parts via the network subsystem 404 over the network 230 to the CRM server 220.

### Providing Information Relating to a Target Person

When the selected record 318 or the entity of interest corresponds to a person, FIG. 1C illustrates a method for providing information relating to a person from a CRM system according to an exemplary embodiment. Here, the method 161 can be implemented in the context of the CRM server 220 of FIG. 2. The method 161 may, however, be carried out in any desired environment. According to an embodiment, the method 161 begins, in block 162, by receiving the message 462b from the user system 400 associated with the requesting user 203. In an embodiment, the message 462b includes a request for information relating to a target person and information identifying the target person. For example, such information can include the target person's name, username, and/or social media handle or alias. In an embodiment, the record handler component 312 is configured to receive the message 462b from the user system 400 associated with a requesting user 203. When the message 462b is received, the record handler component 312 can be configured to identify, in block 164, a plurality of accessible records 315 relating to the target person based on the information identifying the target person.

As indicated above, the accessible records 315 are managed by the CRM system 300 and can include contact records 322 representing people and/or organizations, event records 324, account records 325 representing customers, competitors, and/or partners of an enterprise, and correspondence records 326 representing interactions between users 203, 201a, 201b. Such interactions, e.g., detected by the monitoring agent 305, can include electronic mail messages, text messages, voice and/or video messages, and telephone calls. In an embodiment, the accessible records 315 are associated with an enterprise with which the requesting user 203 is affiliated and are records 320 to which the requesting user 203 is permitted access.

Referring again to FIG. 1C, in addition to identifying the accessible records 315 managed by the CRM system 300, public social media content relating to the target person is collected from at least one social networking entity 205 in block 166. According to an embodiment, the social media content 210 can include the real-time social networking data 207 associated with the target person and/or the social media objects 206 relating to the target person and described above. The social media handler component 312a can be configured to collect the public social media content 210 in an embodiment by logging into at least one of the social networking entities 205 and searching for the social media content 210 relating to the target person using the information included in the message 462b.

Once the accessible records 315 relating to the target person and the social media content 210 relating to the target person are identified and collected, a comprehensive profile associated with the target person is generated based on the identified accessible records 315 and the collected content 210 in block 168. According to an embodiment, the CRM recommendation service 310 can include a profile generator component 350 configured to generate the comprehensive profile 352 associated with the target person based on the plurality of accessible records 315 and the social media content 210.

In an embodiment, the comprehensive profile 352 provides a social and professional portrait of the target person from the perspective of the enterprise associated with the requesting user 203. For example, the comprehensive profile 352 can include information identifying people affiliated with the enterprise and linked, socially and/or professionally, to the target person. In an embodiment, the profile generator component 350 can be configured to identify at least one person to which the target person is linked based on the plurality of accessible records 315 and/or the social media content 210.

For example, the profile generator 350 can sort the accessible records 315 by record type to extract records, e.g., contact records 322, corresponding to people to whom the target person is linked professionally. In addition, the profile generator 350 can analyze the social media content 210, in particular the social networking data 207 that identifies the target person's social media contacts, to determine people to whom the target person is linked socially and whether those people are associated with the enterprise. In an embodiment, a linked person can be socially connected, professionally connected, or both socially and professionally connected to the target person, and the profile generator 350 can be configured to differentiate between the various connections.

Alternatively or in addition, in another embodiment, the comprehensive profile 352 can also include information identifying interactions between the target person and people associated with the enterprise and/or interactions involving the target person. In an embodiment, the profile generator component 350 can be configured to identify, from the accessible records 315, at least one correspondence record 326 representing an interaction directed to the target person, an interaction initiated by the target person, and/or an interaction including a reference to the target person. An interaction can include, for example, an electronic mail message, a text message, a voice message, a telephone call, and a video clip.

In another embodiment, the comprehensive profile 352 can also include information identifying social media activity of the target person relating to or relevant to the enterprise. For example, in an embodiment, the profile generator component 350 can be configured to identify, from the social media content 210 associated with the target person, one or more social media objects 206 relating to the enterprise. The identified social media object(s) 206 can be posted by the target person, posted to the target person, and/or can include a reference to the target person.

According to an embodiment, the linked person information, the correspondence information and the social media activity information identified by the profile generator component 350 can be included in one or more lists. For example, in an embodiment, when at least one linked person is identified, a linked person list 335a that includes information identifying the linked person(s) can be generated. Alternatively or in addition, when the correspondence record(s) 326 and/or the social media object(s) 206 are identified, a correspondence list 335b that includes information identifying the correspondence record(s) 326 and/or a social media list 335c comprising information identifying the social media object(s) 206 can be generated respectively.

For example, in an embodiment, the profile generator 350 can provide the contact records 322 corresponding to the linked person(s), the correspondence records 326 representing interactions directed to, initiated by, and/or including a reference to the target person, and/or the social media objects 206 relating to the target person and to the enterprise to the list handler component 319. The record handler component 319 can be configured to retrieve the record identifier(s) 331 identifying the contact 322, and/or correspondence 326 records. Alternatively or in addition, the record identifiers 331 can be extracted from the records 322, 326 corresponding to the linked persons and/or the interactions. In an embodiment, the list handler component 319 can be configured to generate the linked person 335a and/or the correspondence 335b lists, and to include the record identifiers 331 identifying the records 322, 326 corresponding to the linked person(s) and/or interactions in the respective lists 335a, 335b.

According to an embodiment, each list 335a, 335b, 355c can be a ranked list. For example, the linked persons in the linked person list 335a can be listed in an order according to how well each linked person knows the target person. In an embodiment, a relationship score for each of the at least one linked persons can be calculated based on a plurality of relationship factors 317b that indicate how the linked person is connected to the target person and/or how well the linked person knows the target person. For example, a relationship factor 317b can be related to a frequency with which the target person has interactions with a linked person, i.e., how many times has the target person called, emailed, and/or texted the linked person, and/or can be related to a temporal proximity of an interaction with a linked person, i.e., how recent was the last interaction between the target person and the linked person.

Another relationship factor 317b can be related to a social networking entity 205 with which the linked person is linked to the target person, i.e., whether the linked person is connected to the target person via a business oriented social networking entity and/or via a friendship based social networking entity. In another example, a relationship factor 317b can be related to a status and/or an attribute of the linked person. For example, a status of a linked person can be the linked person's professional title or occupation, and an attribute of the linked person can be a familial relationship or shared school affiliation. Other relationship factors 317b can be defined and directed to a variety of subjects.

In another example, the correspondence records 326 in the correspondence list 335b can be listed in an order according to how important the interactions are to the target person and to the enterprise. In an embodiment, an importance score for each of the at least one correspondence records 326 can be calculated based on a plurality of interaction factors 317c that indicate how important the interaction represented by the correspondence record 326 is to the target person and to the enterprise. For example, an interaction factor 317c can be related to a temporal proximity of an interaction, i.e., how recent was the interaction, and/or can be related to a status of a sender and/or a recipient of an interaction. In addition or alternatively, an interaction factor 317c can be related to a subject matter of an interaction and/or to content of an interaction. Other interaction factors 317c can be defined and directed to a variety of subjects.

In yet another example, the social media objects 206 in the social media list 335c can be listed in an order according to how relevant the social media object 206 is to the enterprise. In an embodiment, a social media score for each of the at least one social media objects 206 can be calculated based on a plurality of media factors 317d that indicate how relevant the social media object 206 is to the enterprise. For example, a media factor 317d can be related to a temporal proximity of a posting of a social media object, i.e., how recent was the social media object 206 posted, and/or can be related to a type of a social media object 206, i.e., whether the social media object 206 is an article or a status update. In addition or alternatively, a media factor 317d can be related to content of a social media object and/or to reactions and comments relating to a social media object 206.

According to an embodiment, each of the plurality of relationship factors 317b can be weighted by a weighting factor to reflect its importance relative to the other relationship factors 317b. Similarly, each of the plurality of interaction factors 317c and/or each of the plurality of media factors 317d can be weighted by respective weighting factors to reflect their importance relative to the other interaction 317c and/or media 317d factors respectively.

In an embodiment, the relevancy score handler component 316 can be configured to calculate the relationship score for each of the at least one linked person(s) based on the plurality of relationship factors 317b, the importance score for each correspondence record 326 based on the plurality of interaction factors 317c and/or the social media score for each social media object 206 based on the plurality of media factors 317d. As described above, a raw score for each relationship 317b, interaction 317c and/or media 317d factor can be determined, in an embodiment, based at least in part on information included in the contact records 322, the correspondence records 326 and/or the social media content 210 relating to the target person.

In an embodiment, the relevancy score handler component 316 can determine the relationship score for the linked person, the importance score for the correspondence record 326, and/or the social media score for the social media object 206 by accumulating the raw scores to generate respective sums of the raw scores. In an embodiment, the sum of the raw scores derived from the relationship factors 317b is the relationship score for the linked person and indicates how well the linked person knows the target person; the sum of the raw scores derived from the interaction factors 317c is the importance score for the correspondence record 326 and indicates how important the interaction is to the target person and to the enterprise; and the sum of the raw scores derived from the media factors 317d is the social media score of the social media object 206 and indicates how relevant the social media object is to the enterprise.

According to an embodiment, the relevancy score handler component 316 can provide to the list handler component 319 the relationship, importance and/or social media scores for the contact records 322, the correspondence records 326, and/or the social media objects 206. The record handler component 319 can be configured to generate the linked person list 335a and to order the linked person(s) by relationship score. Similarly, the record handler component 319 can generate the correspondence list 335b and/or the social media list 335c and can order the correspondence records 326 and/or the social media objects 206 by importance and social media scores respectively.

Referring again to FIG. 1C, in block 170, once the comprehensive profile 352 associated with the target person is generated, a response message including at least a portion of the comprehensive profile 352 is transmitted to the user system 400 associated with the user 203. According to an embodiment, the list handler component 319 is configured to build and transmit a second response message 334a including at least a portion of the comprehensive profile 352 associated with the target person to the user system 400.

In an embodiment, the request for information relating to the target person can specify a particular type of information in which the requesting user 203 is interested. For example, in an embodiment, when the message 462b includes a specific request for persons linked to the target person, the list handler component 319 can be configured to build and transmit a second response message 334a that includes the linked person list 335a. Similarly, when the message 462b includes a request for correspondence and/or social media objects relating to the target person, the list handler component 319 can be configured to build and transmit a second response message 334a that includes the correspondence list 335b and/or the social media list 335c. According to an embodiment, when the message 462b includes a request that does not specify a particular type of information, the list handler component 319 can be configured to build and transmit a second response message 334a that includes the comprehensive profile 352 comprising the linked person list 335a, the correspondence list 335b and the social media list 335c.

As described above, the list handler component 319 can be configured, in an embodiment, to provide the second response message 334a to the outgoing data handler 309 in the CRM system 300. In an embodiment, the outgoing data handler 309 can interoperate directly with the protocol layer of the network subsystem 302 or with the application protocol layer 303. The message 334a can be transmitted as a whole or in parts via the network subsystem 302 over the network 230 to the user system 400 associated with the requesting user 203.

In an embodiment, when the second response message 334a arrives at the user system 400, the display handler component 480 in the recommendation component 450 can be configured to receive the second response message 334a via the incoming data handler 409 in the user system 400. In an embodiment, when the response message 334a is received, the display handler component 480 can be configured to display at least a portion of the comprehensive profile 352 associated with the target person on the display component 430 of the user system 400. FIG. 5E illustrates an exemplary user interface 500e displayed by the user system 400 presenting information relating to a target person according to an embodiment.

In an embodiment, the user interface 500e can include a plurality of presentation windows for displaying information relating to the target person, Tom Smith. For example, the user interface 500e can include a presentation window 520 for displaying icons 521 representing the linked persons to which Tom Smith is connected. Each icon 521 can identify the linked person by name and/or social media handle or username. In addition, contact information 522 associated with the linked person can be included as well. The requesting user 203 may or may not be connected to any of the linked persons listed. Nevertheless, because the linked persons and the requesting user 203 are affiliated with the enterprise, the requesting user 203 can contact one or more of the linked persons to ask for an introduction when the requesting user 203 wants to meet Tom Smith.

In an embodiment, the user interface 500e can also include presentation windows for presenting enterprise correspondence and social media objects relating to the target person. For example, a correspondence presentation window 530 can present the interactions 532 between Tom Smith and others associated with the enterprise and/or interactions involving Tom Smith and the enterprise. In this manner, the requesting user 203 can determine whether Tom Smith is actively engaged with the enterprise, and can be aware of what has been communicated to Tom Smith most recently. In another embodiment, a social media presentation window 540 can present Tom Smith's social media activity related to the enterprise from at least one social networking entity 205. For example, the social media presentation window 540 can display Tom Smith's most recent post 542 relating to an upcoming meeting with the enterprise, and can also display Tom Smith's micro blogs and other social media objects.

In another embodiment, the user interface 500e can also include an enterprise influence score 550 for the target person which indicates how influential the target person is to the enterprise. According to an embodiment, the relevancy score handler component 316 can be configured to calculate the influence score 550 for the target person based on a plurality of enterprise factors 317e that indicate how important the target person is to the enterprise. For example, an enterprise factor 317e can be related to a number of accounts and/or opportunities in which the target person is involved, and/or a total and potential amount of revenue generated from accounts in which the target person is involved. In addition, another enterprise factor 317e can be related to a status and/or an attribute of the target person, i.e., whether the target person is a high ranking officer of a customer doing business with the enterprise. Another enterprise factor 317e can be related to a status and/or an attribute of a contact of the target person, i.e., whether a contact of the target person is a high ranking officer of the enterprise.

According to an embodiment, and as described above, the relevancy score handler component 316 can be configured to calculate the influence score 550 by determining a raw score for each of the plurality of enterprise factors 317e based at least in part on information included in the contact records 322, account records 325, correspondence records 326 and/or the social media content 210 relating to the target person. In an embodiment, the raw scores are accumulated to generate the enterprise influence score 550 which indicates how influential the target person is to the enterprise. In an embodiment, the enterprise influence score 550 can be included in the comprehensive profile 352 associated with the target person, which is included in the second response message 334a that is transmitted to the requesting user 203.

### Providing Information Relating to an Account

When the selected record 318 or the entity of interest corresponds to an account record 325 representing a target account, a similar process to the process for providing information relating to the target person can be applied for providing information relating to the target account. For example, FIG. 1D illustrates a method for providing information relating to a target account from a CRM system according to an exemplary embodiment. According to an embodiment, the method 171 begins, in block 172, by receiving the message 462b from the user system 400 associated with the requesting user 203. In an embodiment, the message 462b includes a request for information relating to a target account representing at least one of a customer, competitor and partner of an enterprise, and information identifying the target account. As described earlier, the record handler component 312 is configured to receive the message 462b from the user system 400 associated with a requesting user 203. When the message 462b is received, the record handler component 312 can be configured to identify, in block 174, a plurality of accessible records 315 relating to the target account based on the information identifying the target account. As stated earlier, the plurality of accessible records 315 can include contact records 322, event records 324, account records 325, correspondence records 326, and other records 327 relating to the target account.

Referring again to FIG. 1D, in addition to identifying the accessible records 315 managed by the CRM system 300, public social media content 210 relating to the target account is collected from at least one social networking entity 205 in block 176. According to an embodiment, the social media content 210 can include the real-time social networking data 207 and/or the social media objects 206 described above. The social media handler component 312a can be configured to collect the public social media content 210 in an embodiment by logging into at least one of the social networking entities 205 and searching for the social media content 210 relating to the target account using the information included in the message 462b.

Once the accessible records 315 relating to the target account and the social media content 210 relating to the target account are identified and collected, a comprehensive account profile 352a associated with the target account can be generated based on the identified accessible records 315 and the collected content 210 in block 178. According to an embodiment, the profile generator component 350 can generate the comprehensive account profile 352a associated with the target account, which provides a comprehensive view of the target account with respect to the enterprise associated with the requesting user 203.

For example, the account profile 352a can include information identifying people linked, socially and/or professionally, to the target account. The linked people can be affiliated with the enterprise and/or with the account, and can be involved in business transactions, i.e., sales and opportunities, between the enterprise and the account in an embodiment. Alternatively or in addition, the account profile 352a can include information identifying interactions between the target account and people affiliated with the enterprise and/or interactions involving the target account. Moreover, the account profile 352a can include information identifying the social media activity of the target account relating to or relevant to the enterprise.

According to an embodiment, the linked person information, the interaction information and the social media activity information can be included in one or more lists which can then be included in the account profile 352a. For example, in an embodiment, the linked person list 335a can include information identifying the linked persons, the correspondence list 335b can include information identifying the interactions involving the target account, and the social media list 335c can include the information identifying the social media object(s) 206 relating to the social media activity of the target account.

Like the lists included in the comprehensive profile 352 associated with the target person, the lists in the account profile 352a can be ranked lists. For example, the linked persons in the linked person list 335a, the interactions in the correspondence list 335b, and/or the social media objects 206 in the social media list 335c can be listed in an order according to how relevant each linked person, interaction, and/or social media object is to the target account. In an embodiment, at least one of the plurality of the relevance factors 317 can reflect how relevant a person, interaction or social media object is to the target account. In an embodiment, such relevance factors 317 can be related to a number of transactions involving the target account and a linked person, an amount of revenue generated by the linked person, a temporal proximity of an interaction, a subject matter and/or content of an interaction, a status and/or an attribute of a sender and/or recipient of an interaction message, content of a social media object 206, reactions and comments relating to a social media object, a type of a social media object, and/or a temporal proximity of a posting of the social media object 206. As described above, the relevancy score handler component 316 can be configured to calculate relevance scores for each of the linked persons, interactions and social media objects 206 based on the plurality of relevance factors 317, and the record handler component 319 can be configured to generate the ranked linked person list 335a, the ranked correspondence list 335b, and/or the ranked social media list 335c.

Referring again to FIG. 1D, in block 180, once the comprehensive account profile 352a associated with the target account is generated, a third response message 334b including at least a portion of the comprehensive account profile 352a is transmitted to the user system 400 associated with the requesting user 203. Similar to the request for information relating to the target person, the request for information relating to the target account can specify a particular type of information in which the requesting user 203 is interested. Accordingly, the list handler component 319 can be configured to build and transmit a third response message 334b that includes the linked person list 335a, the correspondence list 335b and/or the social media list 335c depending on the type of information specified in the request.

In an embodiment, when the third response message 334b arrives at the requesting user system 400, the display handler component 480 can be configured to display at least a portion of the comprehensive account profile 352a associated with the target account on the display component 430 of the user system 400. FIG. 5F illustrates an exemplary user interface 500f displayed by the user system 400 presenting information relating to the target account according to an embodiment.

In an embodiment, the user interface 500f is similar to the user interface 500e of FIG. 5F described above, and can include presentation windows for displaying information relating to the target account, Data Mart. For example, the user interface 500f can include a presentation window 520a for displaying icons 521a representing affiliated linked persons that are affiliated with the account, where each icon 521a identifies the affiliated person by name and/or social media handle or username. In addition, contact information 522a associated with the affiliated person can be included as well. The requesting user 203 may or may not be connected to any of the persons listed. Nevertheless, because the affiliated persons and the requesting user 203 are affiliated with the enterprise, the requesting user 203 can contact one or more of the affiliated persons to learn more about Data Mart and/or to develop new opportunities with Data Mart.

In an embodiment, the user interface 500f can also include presentation windows for presenting enterprise correspondence and social media objects relating to the target account, Data Mart. For example, a correspondence presentation window 530a can present the interactions 532a involving Data Mart and the enterprise. In this manner, the requesting user 203 can determine whether and with whom Data Mart is actively engaged, and can be aware of what has been communicated to Data Mart most recently. In another embodiment, a social media presentation window 540a can present Data Mart's social media activity related to the enterprise from at least one social networking entity 205. For example, the social media presentation window 540a can display Data Mart's most recent post 542a relating to a collaboration with the enterprise, and can also display Data Mart's micro blogs and other social media objects.

In another embodiment, the user interface 500f can also include an account importance score 570 for the target account which indicates how important the target account is to the enterprise. According to an embodiment, the relevancy score handler component 316 can be configured to calculate the account importance score 570 for the target account based on the plurality of enterprise factors 317e that indicate how important the target account is to the enterprise. For example, an enterprise factor 317e can be related to a number of transactions and/or opportunities that are pending or developing between the target account and the enterprise, a total and/or potential amount of revenue generated from or by the target account, and/or a status and/or attribute of the target account.

According to an embodiment, and as described above, the relevancy score handler component 316 can be configured to calculate the account importance score 570 by determining a raw score for each of the plurality of enterprise factors 317e based at least in part on information included in the contact records 322, the account records 325, the correspondence records 326 and/or the social media content 210 relating to the target account. In an embodiment, the raw scores are accumulated to generate the account importance score 570 which indicates how important the target account is to the enterprise. In an embodiment, the enterprise influence score 570 can be included in the comprehensive account profile 352a associated with the target account, which is included in the third response message 334b that is transmitted to the requesting user 203.

### System Overview

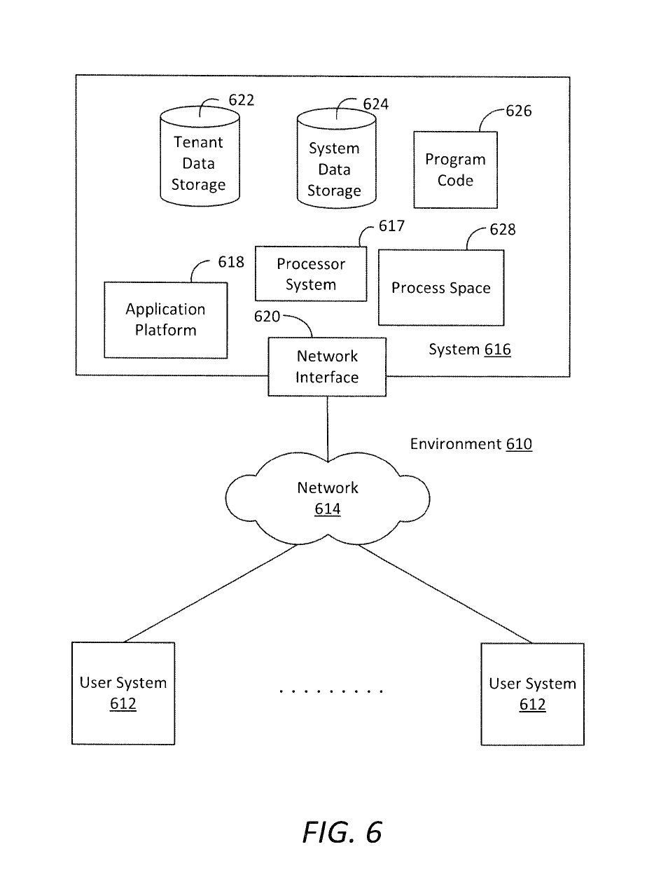

FIG. 6 illustrates a block diagram of an environment 610 wherein an on-demand database service might be used. Environment 610 may include user systems 612, network 614, system 616, processor system 617, application platform 618, network interface 620, tenant data storage 622, system data storage 624, program code 626, and process space 628. In other embodiments, environment 610 may not have all of the components listed and/or may have other elements instead of, or in addition to, those listed above.

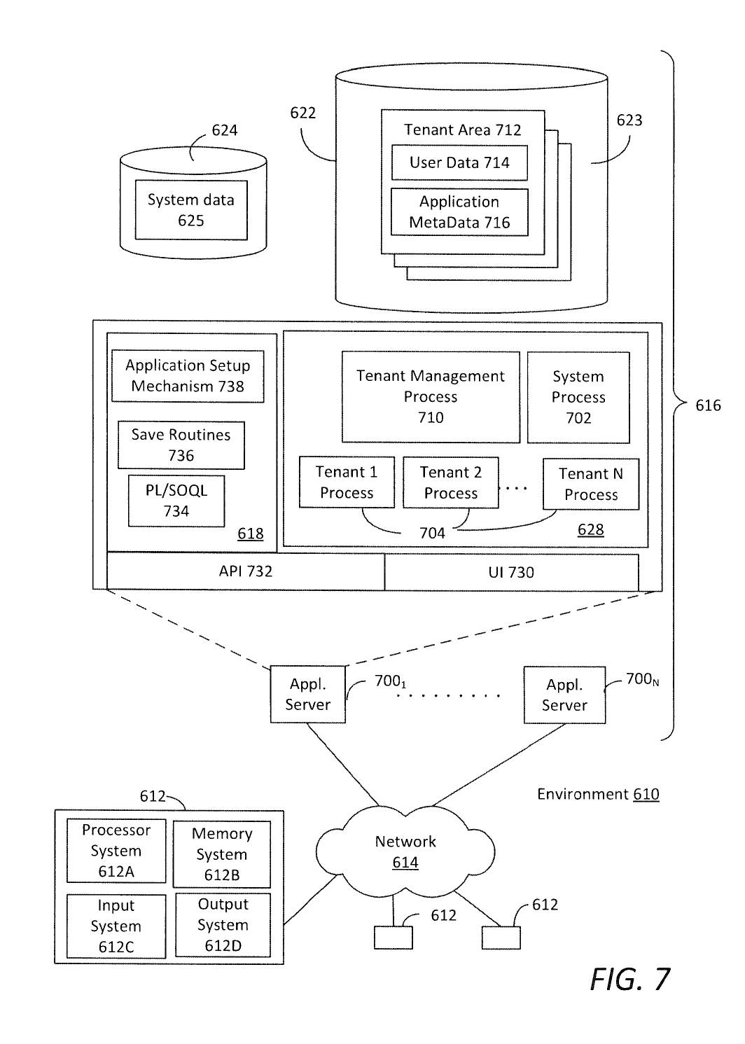

Environment 610 is an environment in which an on-demand database service exists. User system 612 may be any machine or system that is used by a user to access a database user system. For example, any of user systems 612 can be a handheld computing device, a mobile phone, a laptop computer, a work station, and/or a network of computing devices. As illustrated in FIG. 6 (and in more detail in FIG. 7) user systems 612 might interact via a network 614 with an on-demand database service, which is system 616.

An on-demand database service, such as system 616, is a database system that is made available to outside users that do not need to necessarily be concerned with building and/or maintaining the database system, but instead may be available for their use when the users need the database system (e.g., on the demand of the users). Some on-demand database services may store information from one or more tenants stored into tables of a common database image to form a multi-tenant database system (MTS). Accordingly, “on-demand database service 616” and “system 616” will be used interchangeably herein. A database image may include one or more database objects. A relational database management system (RDMS) or the equivalent may execute storage and retrieval of information against the database object(s). Application platform 618 may be a framework that allows the applications of system 616 to run, such as the hardware and/or software, e.g., the operating system. In an embodiment, on-demand database service 616 may include an application platform 618 that enables creation, managing and executing one or more applications developed by the provider of the on-demand database service, users accessing the on-demand database service via user systems 612, or third party application developers accessing the on-demand database service via user systems 612.

The users of user systems 612 may differ in their respective capacities, and the capacity of a particular user system 612 might be entirely determined by permissions (permission levels) for the current user. For example, where a salesperson is using a particular user system 612 to interact with system 616, that user system has the capacities allotted to that salesperson. However, while an administrator is using that user system to interact with system 616, that user system has the capacities allotted to that administrator. In systems with a hierarchical role model, users at one permission level may have access to applications, data, and database information accessible by a lower permission level user, but may not have access to certain applications, database information, and data accessible by a user at a higher permission level. Thus, different users will have different capabilities with regard to accessing and modifying application and database information, depending on a user's security or permission level.

Network 614 is any network or combination of networks of devices that communicate with one another. For example, network 614 can be any one or any combination of a LAN (local area network), WAN (wide area network), telephone network, wireless network, point-to-point network, star network, token ring network, hub network, or other appropriate configuration. As the most common type of computer network in current use is a TCP/IP (Transfer Control Protocol and Internet Protocol) network, such as the global internetwork of networks often referred to as the “Internet” with a capital “I,” that network will be used in many of the examples herein. However, it should be understood that the networks that the one or more implementations might use are not so limited, although TCP/IP is a frequently implemented protocol.

User systems 612 might communicate with system 616 using TCP/IP and, at a higher network level, use other common Internet protocols to communicate, such as HTTP, FTP, AFS, WAP, etc. In an example where HTTP is used, user system 612 might include an HTTP client commonly referred to as a “browser” for sending and receiving HTTP messages to and from an HTTP server at system 616. Such an HTTP server might be implemented as the sole network interface between system 616 and network 614, but other techniques might be used as well or instead. In some implementations, the interface between system 616 and network 614 includes load sharing functionality, such as round-robin HTTP request distributors to balance loads and distribute incoming HTTP requests evenly over a plurality of servers. At least as for the users that are accessing that server, each of the plurality of servers has access to the MTS' data; however, other alternative configurations may be used instead.

In one embodiment, system 616, shown in FIG. 6, implements a web-based customer relationship management (CRM) system. For example, in one embodiment, system 616 includes application servers configured to implement and execute CRM software applications as well as provide related data, code, forms, webpages and other information to and from user systems 612 and to store to, and retrieve from, a database system related data, objects, and Webpage content. With a multi-tenant system, data for multiple tenants may be stored in the same physical database object, however, tenant data typically is arranged so that data of one tenant is kept logically separate from that of other tenants so that one tenant does not have access to another tenant's data, unless such data is expressly shared. In certain embodiments, system 616 implements applications other than, or in addition to, a CRM application. For example, system 616 may provide tenant access to multiple hosted (standard and custom) applications, including a CRM application. User (or third party developer) applications, which may or may not include CRM, may be supported by the application platform 618, which manages creation, storage of the applications into one or more database objects and executing of the applications in a virtual machine in the process space of the system 616.

One arrangement for elements of system 616 is shown in FIG. 6, including a network interface 620, application platform 618, tenant data storage 622 for tenant data 623, system data storage 624 for system data 625 accessible to system 616 and possibly multiple tenants, program code 626 for implementing various functions of system 616, and a process space 628 for executing MTS system processes and tenant-specific processes, such as running applications as part of an application hosting service. Additional processes that may execute on system 616 include database indexing processes.

Several elements in the system shown in FIG. 6 include conventional, well-known elements that are explained only briefly here. For example, each user system 612 could include a desktop personal computer, workstation, laptop, PDA, cell phone, or any wireless access protocol (WAP) enabled device or any other computing device capable of interfacing directly or indirectly to the Internet or other network connection. User system 612 typically runs an HTTP client, e.g., a browsing program, such as Microsoft's Internet Explorer browser, Netscape's Navigator browser, Opera's browser, or a WAP-enabled browser in the case of a cell phone, PDA or other wireless device, or the like, allowing a user (e.g., subscriber of the multi-tenant database system) of user system 612 to access, process and view information, pages and applications available to it from system 616 over network 614. Each user system 612 also typically includes one or more user interface devices, such as a keyboard, a mouse, trackball, touch pad, touch screen, pen or the like, for interacting with a graphical user interface (GUI) provided by the browser on a display (e.g., a monitor screen, LCD display, etc.) in conjunction with pages, forms, applications and other information provided by system 616 or other systems or servers. For example, the user interface device can be used to access data and applications hosted by system 616, and to perform searches on stored data, and otherwise allow a user to interact with various GUI pages that may be presented to a user. As discussed above, embodiments are suitable for use with the Internet, which refers to a specific global internetwork of networks. However, it should be understood that other networks can be used instead of the Internet, such as an intranet, an extranet, a virtual private network (VPN), a non-TCP/IP based network, any LAN or WAN or the like.

According to one embodiment, each user system 612 and all of its components are operator configurable using applications, such as a browser, including computer code run using a central processing unit such as an Intel Pentium® processor or the like. Similarly, system 616 (and additional instances of an MTS, where more than one is present) and all of their components might be operator configurable using application(s) including computer code to run using a central processing unit such as processor system 617, which may include an Intel Pentium® processor or the like, and/or multiple processor units. A computer program product embodiment includes a machine-readable storage medium (media) having instructions stored thereon/in which can be used to program a computer to perform any of the processes of the embodiments described herein. Computer code for operating and configuring system 616 to intercommunicate and to process webpages, applications and other data and media content as described herein are preferably downloaded and stored on a hard disk, but the entire program code, or portions thereof, may also be stored in any other volatile or non-volatile memory medium or device as is well known, such as a ROM or RAM, or provided on any media capable of storing program code, such as any type of rotating media including floppy disks, optical discs, digital versatile disk (DVD), compact disk (CD), microdrive, and magneto-optical disks, and magnetic or optical cards, nanosystems (including molecular memory ICs), or any type of media or device suitable for storing instructions and/or data. Additionally, the entire program code, or portions thereof, may be transmitted and downloaded from a software source over a transmission medium, e.g., over the Internet, or from another server, as is well known, or transmitted over any other conventional network connection as is well known (e.g., extranet, VPN, LAN, etc.) using any communication medium and protocols (e.g., TCP/IP, HTTP, HTTPS, Ethernet, etc.) as are well known. It will also be appreciated that computer code for implementing embodiments can be implemented in any programming language that can be executed on a client system and/or server or server system such as, for example, C, C++, HTML, any other markup language, Java™, JavaScript, ActiveX, any other scripting language, such as VBScript, and many other programming languages as are well known may be used. (Java™ is a trademark of Sun Microsystems, Inc.).

According to one embodiment, each system 616 is configured to provide webpages, forms, applications, data and media content to user (client) systems 612 to support the access by user systems 612 as tenants of system 616. As such, system 616 provides security mechanisms to keep each tenant's data separate unless the data is shared. If more than one MTS is used, they may be located in close proximity to one another (e.g., in a server farm located in a single building or campus), or they may be distributed at locations remote from one another (e.g., one or more servers located in city A and one or more servers located in city B). As used herein, each MTS could include one or more logically and/or physically connected servers distributed locally or across one or more geographic locations. Additionally, the term “server” is meant to include a computer system, including processing hardware and process space(s), and an associated storage system and database application (e.g., OODBMS or RDBMS) as is well known in the art. It should also be understood that “server system” and “server” are often used interchangeably herein. Similarly, the database object described herein can be implemented as single databases, a distributed database, a collection of distributed databases, a database with redundant online or offline backups or other redundancies, etc., and might include a distributed database or storage network and associated processing intelligence.

FIG. 7 also illustrates environment 610. However, in FIG. 7 elements of system 616 and various interconnections in an embodiment are further illustrated. FIG. 7 shows that user system 612 may include processor system 612A, memory system 612B, input system 612C, and output system 612D. FIG. 7 shows network 614 and system 616. FIG. 7 also shows that system 616 may include tenant data storage 622, tenant data 623, system data storage 624, system data 625, User Interface (UI) 730, Application Program Interface (API) 732, PL/SOQL 734, save routines 736, application setup mechanism 738, applications servers 7001-700N, system process space 702, tenant process spaces 704, tenant management process space 710, tenant storage area 712, user data storage 714, and application metadata 716. In other embodiments, environment 610 may not have the same elements as those listed above and/or may have other elements instead of, or in addition to, those listed above.

User system 612, network 614, system 616, tenant data storage 622, and system data storage 624 were discussed above in FIG. 6. Regarding user system 612, processor system 612A may be any combination of one or more processors. Memory system 612B may be any combination of one or more memory devices, short term, and/or long term memory. Input system 612C may be any combination of input devices, such as one or more keyboards, mice, trackballs, scanners, cameras, and/or interfaces to networks. Output system 612D may be any combination of output devices, such as one or more monitors, printers, and/or interfaces to networks. As shown by FIG. 7, system 616 may include a network interface 620 (of FIG. 6) implemented as a set of HTTP application servers 7001-700N, an application platform 618, tenant data storage 622, and system data storage 624. Also shown is system process space 702, including individual tenant process spaces 704 and a tenant management process space 710. Each application server 7001-700N may be configured to tenant data storage 622 and the tenant data 623 therein, and system data storage 624 and the system data 625 therein to serve requests of user systems 612. The tenant data 623 might be divided into individual tenant storage areas 712, which can be either a physical arrangement and/or a logical arrangement of data. Within each tenant storage area 712, user data storage 714 and application metadata 716 might be similarly allocated for each user. For example, a copy of a user's most recently used (MRU) items might be stored to user data storage 714. Similarly, a copy of MRU items for an entire organization that is a tenant might be stored to tenant storage area 712. A UI 730 provides a user interface and an API 732 provides an application programmer interface to system 616 resident processes to users and/or developers at user systems 612. The tenant data 623 and the system data 625 may be stored in various databases, such as one or more Oracle™ databases.

Application platform 618 includes an application setup mechanism 738 that supports application developers' creation and management of applications, which may be saved as metadata into tenant data storage 622 by save routines 736 for execution by subscribers as one or more tenant process spaces 704 managed by tenant management process 710 for example. Invocations to such applications may be coded using PL/SOQL 734 that provides a programming language style interface extension to API 732. A detailed description of some PL/SOQL language implementations is discussed in commonly assigned U.S. Pat. No. 7,730,478, titled METHOD AND SYSTEM FOR ALLOWING ACCESS TO DEVELOPED APPLICATIONS VIA A MULTI-TENANT ON-DEMAND DATABASE SERVICE, by Craig Weissman, filed Sep. 21, 2007, which is hereby incorporated by reference in its entirety and for all purposes. Invocations to applications may be detected by one or more system processes, which manages retrieving application metadata 716 for the subscriber making the invocation and executing the metadata as an application in a virtual machine.

Each application server 7001-700N may be communicably coupled to database systems, e.g., having access to system data 625 and tenant data 623, via a different network connection. For example, one application server 7001 might be coupled via the network 614 (e.g., the Internet), another application server 700N−1 might be coupled via a direct network link, and another application server 700N might be coupled by yet a different network connection. Transfer Control Protocol and Internet Protocol (TCP/IP) are typical protocols for communicating between application servers 7001-700N and the database system. However, it will be apparent to one skilled in the art that other transport protocols may be used to optimize the system depending on the network interconnect used.

In certain embodiments, each application server 7001-700N is configured to handle requests for any user associated with any organization that is a tenant. Because it is desirable to be able to add and remove application servers from the server pool at any time for any reason, there is preferably no server affinity for a user and/or organization to a specific application server 7001-700N. In one embodiment, therefore, an interface system implementing a load balancing function (e.g., an F5 Big-IP load balancer) is communicably coupled between the application servers 7001-700N and the user systems 612 to distribute requests to the application servers 7001-700N. In one embodiment, the load balancer uses a least connections algorithm to route user requests to the application servers 7001-700N. Other examples of load balancing algorithms, such as round robin and observed response time, also can be used. For example, in certain embodiments, three consecutive requests from the same user could hit three different application servers 7001-700N, and three requests from different users could hit the same application server 7001-700N. In this manner, system 616 is multi-tenant, wherein system 616 handles storage of, and access to, different objects, data and applications across disparate users and organizations.

As an example of storage, one tenant might be a company that employs a sales force where each salesperson uses system 616 to manage their sales process. Thus, a user might maintain contact data, leads data, customer follow-up data, performance data, goals and progress data, etc., all applicable to that user's personal sales process (e.g., in tenant data storage 622). In an example of a MTS arrangement, since all of the data and the applications to access, view, modify, report, transmit, calculate, etc., can be maintained and accessed by a user system having nothing more than network access, the user can manage his or her sales efforts and cycles from any of many different user systems. For example, if a salesperson is visiting a customer and the customer has Internet access in their lobby, the salesperson can obtain critical updates as to that customer while waiting for the customer to arrive in the lobby.

While each user's data might be separate from other users' data regardless of the employers of each user, some data might be organization-wide data shared or accessible by a plurality of users or all of the users for a given organization that is a tenant. Thus, there might be some data structures managed by system 616 that are allocated at the tenant level while other data structures might be managed at the user level. Because an MTS might support multiple tenants including possible competitors, the MTS should have security protocols that keep data, applications, and application use separate. Also, because many tenants may opt for access to an MTS rather than maintain their own system, redundancy, up-time, and backup are additional functions that may be implemented in the MTS. In addition to user-specific data and tenant specific data, system 616 might also maintain system level data usable by multiple tenants or other data. Such system level data might include industry reports, news, postings, and the like that are sharable among tenants.

In certain embodiments, user systems 612 (which may be client systems) communicate with application servers 7001-700N to request and update system-level and tenant-level data from system 616 that may require sending one or more queries to tenant data storage 622 and/or system data storage 624. System 616 (e.g., an application server 7001 in system 616) automatically generates one or more SQL statements (e.g., one or more SQL queries) that are designed to access the desired information. System data storage 624 may generate query plans to access the requested data from the database.

Each database can generally be viewed as a collection of objects, such as a set of logical tables, containing data fitted into predefined categories. A “table” is one representation of a data object, and may be used herein to simplify the conceptual description of objects and custom objects. It should be understood that “table” and “object” may be used interchangeably herein. Each table generally contains one or more data categories logically arranged as columns or fields in a viewable schema. Each row or record of a table contains an instance of data for each category defined by the fields. For example, a CRM database may include a table that describes a customer with fields for basic contact information such as name, address, phone number, fax number, etc. Another table might describe a purchase order, including fields for information such as customer, product, sale price, date, etc. In some multi-tenant database systems, standard entity tables might be provided for use by all tenants. For CRM database applications, such standard entities might include tables for Account, Contact, Lead, and Opportunity data, each containing pre-defined fields. It should be understood that the word “entity” may also be used interchangeably herein with “object” and “table”.

In some multi-tenant database systems, tenants may be allowed to create and store custom objects, or they may be allowed to customize standard entities or objects, for example by creating custom fields for standard objects, including custom index fields. U.S. Pat. No. 7,779,039, titled CUSTOM ENTITIES AND FIELDS IN A MULTI-TENANT DATABASE SYSTEM, by Weissman, et al., and which is hereby incorporated by reference in its entirety and for all purposes, teaches systems and methods for creating custom objects as well as customizing standard objects in a multi-tenant database system. In certain embodiments, for example, all custom entity data rows are stored in a single multi-tenant physical table, which may contain multiple logical tables per organization. It is transparent to customers that their multiple “tables” are in fact stored in one large table or that their data may be stored in the same table as the data of other customers.

While one or more implementations and techniques have been described with reference to an embodiment in which techniques for providing machine status information in a system having an application server providing a front end for an on-demand database service capable of supporting multiple tenants, the one or more implementations and techniques are not limited to multi-tenant databases nor deployment on application servers. Embodiments may be practiced using other database architectures, i.e., ORACLE®, DB2® by IBM and the like without departing from the scope of the embodiments claimed.

Any of the above embodiments may be used alone or together with one another in any combination. The one or more implementations encompassed within this specification may also include embodiments that are only partially mentioned or alluded to or are not mentioned or alluded to at all. Although various embodiments may have been motivated by various deficiencies with the prior art, which may be discussed or alluded to in one or more places in the specification, the embodiments do not necessarily address any of these deficiencies. In other words, different embodiments may address different deficiencies that may be discussed in the specification. Some embodiments may only partially address some deficiencies or just one deficiency that may be discussed in the specification, and some embodiments may not address any of these deficiencies.

While one or more implementations have been described by way of example and in terms of the specific embodiments, it is to be understood that one or more implementations are not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

1. A method for providing information relating to a person from a customer relation management system, the method comprising:
receiving, by a server, a message from a user system associated with a requesting user, the message including a request for information relating to a target person and further including information identifying the target person;
identifying, by the server, based on the information identifying the target person, a plurality of accessible records associated with an enterprise and relating to the target person, the plurality of records managed by a customer relation management (CRM) system;
collecting, by the server, public social media content relating to the target person from at least one social networking entity, the social media content comprising at least one of public social networking data and public social media objects;
generating, by the server, a comprehensive profile associated with the target person based on the plurality of accessible records and the social media content; and
transmitting, by the server, a response message to the user system, the response message including at least a portion of the comprehensive profile associated with the target person.

2. The method of claim 1 wherein receiving the message from the user system comprises receiving the message over a network, wherein the network is at least one of a public and a private network, and wherein the CRM system includes a multi-tenant on-demand database system.

3. The method of claim 1 wherein the plurality of accessible records associated with the enterprise includes at least one of contact records, account records and correspondence records.

4. The method of claim 1 wherein social networking data includes at least one of information identifying at least one following entity following the target person and information identifying at least one entity followed by the target person, and wherein social media objects include at least one of messages, audio/video objects and image objects at least one of posted and received by the target person.

5. The method of claim 1 wherein generating the comprehensive profile associated with the target person comprises:
identifying at least one linked person to which the target person is linked based on at least one of the plurality of accessible records and the social media content, wherein the at least one linked person is associated with the enterprise; and
generating a linked person list comprising information identifying the at least one linked person.

6. The method of claim 5 wherein generating the linked person list comprises calculating a relationship score for each of the at least one linked person based on a plurality of relationship factors, wherein the relationship score for a linked person indicates how well the linked person knows the target person, and ordering the at least one linked person on the linked person list by relationship score.

7. The method of claim 6 wherein the plurality of relationship factors is related to at least one of a frequency with which the target person has interactions with a linked person, a temporal proximity of an interaction with a linked person, a social networking entity with which the linked person is linked to the target person, and at least one of a status and an attribute of the linked person.

8. The method of claim 5 wherein the request for information relating to the target person includes a request for persons linked to the target person, and wherein the response message to the user system includes the linked person list.

9. The method of claim 1 further wherein generating the comprehensive profile associated with the target person comprises:
identifying at least one correspondence record representing at least one of an interaction directed to the target person, an interaction initiated by the target person, and an interaction including a reference to the target person, wherein the interaction is at least one of an electronic mail message, an instant text message, a voice message, a telephone call, and a video clip; and
generating a correspondence list comprising information identifying the at least one correspondence record.

10. The method of claim 9 wherein generating the correspondence list includes calculating an importance score for the correspondence record based on a plurality of interaction factors, wherein the importance score indicates how important the interaction is to the target person and to the enterprise, and ordering the at least one correspondence record on the correspondence list by importance score.

11. The method of claim 10 wherein the plurality of interaction factors is related to at least one of a temporal proximity of an interaction, a status of at least one of a sender and a recipient of an interaction, a subject matter of an interaction, and content of an interaction.

12. The method of claim 9 wherein the request for information relating to the target person includes a request for correspondence related to the target person, and wherein the response message to the user system includes the correspondence list.

13. The method of claim 1 wherein generating the comprehensive profile associated with the target person comprises:
identifying at least one social media object relating to at least one of the target person and to the enterprise, wherein the at least one social media object is at least one of posted by the target person, posted to the target person, and includes a reference to the target person; and
generating a social media list comprising information identifying the at least one social media object.

14. The method of claim 13 wherein generating the social media list comprises calculating a social media score for each of the at least one social media objects based on a plurality of media factors, wherein the social media score for a social media object indicates how relevant the social media object is to the enterprise, and ordering the at least one social media object on the social media list by social media score.

15. The method of claim 14 wherein the plurality of media factors is related to at least one of a temporal proximity of a posting of a social media object, a type of a social media object, content of a social media object, and reactions and comments relating to a social media object.

16. The method of claim 13 wherein the request for information relating to the target person includes a request for social media objects relating to the target person, and wherein the response message to the user system includes the social media list.

17. The method of claim 1 further comprising calculating an enterprise influence score for the target person based on a plurality of enterprise factors, wherein the enterprise influence score indicates how influential the target person is to the enterprise.

18. The method of claim 17 wherein the plurality of enterprise factors is related to at least one of a number of accounts and/or opportunities in which the target person is involved, a total and a potential amount of revenue generated from accounts in which the target person is involved, a status and an attribute of the target person, and a status and an attribute of a contact of the target person.

19. A machine-readable medium carrying one or more sequences of instructions for providing information relating to a person from a customer relation management system, which instructions, when executed by one or more processors, cause the one or more processors to carry out the steps of:
receiving a message from a user system associated with a requesting user, the message including a request for information relating to a target person and further including information identifying the target person;
identifying based on the information identifying the target person, a plurality of accessible records associated with an enterprise and relating to the target person, the plurality of accessible records managed by a customer relation management (CRM) system;
collecting public social media content relating to the target person from at least one social networking entity, the social media content comprising at least one of public social networking data and public social media objects;
generating a comprehensive profile associated with the target person based on the plurality of accessible records and the social media content; and
transmitting a response message to the user system, the response message including at least a portion of the comprehensive profile associated with the target person.

20. An apparatus for providing information relating to a person from a customer relation management system, the apparatus comprising:
a processor; and
one or more stored sequences of instructions which, when executed by the processor, cause the processor to carry out the steps of:
receiving a message from a user system associated with a requesting user, the message including a request for information relating to a target person and further including information identifying the target person;
identifying based on the information identifying the target person, a plurality of accessible records associated with an enterprise and relating to the target person, the plurality of accessible records managed by a customer relation management (CRM) system;
collecting public social media content relating to the target person from at least one social networking entity, the social media content comprising at least one of public social networking data and public social media objects;
generating a comprehensive profile associated with the target person based on the plurality of accessible records and the social media content; and
transmitting a response message to the user system, the response message including at least a portion of the comprehensive profile associated with the target person.
